(19) United States
(12) Patent Application Publication
(10) Pub. No.: US 2026/0320350 A1
(43) Pub. Date: Oct. 15, 2026

(54) SYSTEMS AND METHODS FOR KEY-VALUE CACHING IN SPECULATIVE DECODING

(71) Applicant: Groq, Inc., San Jose, CA (US)

(72) Inventors: Chenyu Wang, Toronto (CA); Joshua Alexander Hay, Town of Superior, WI (US)

(21) Appl. No.: 19/465,505

(22) Filed: Jan. 30, 2026

Related U.S. Application Data
(60) Provisional application No. 63/752,275, filed on Jan. 31, 2025.
(60) Provisional application No. 63/758,162, filed on Feb. 13, 2025.
(60) Provisional application No. 63/773,545, filed on Mar. 18, 2025.
(60) Provisional application No. 63/767,921, filed on Mar. 6, 2025.

(51) Int. Cl. G06N 3/045

(52) U.S. Cl. CPC G06N 3/045

(57) ABSTRACT

Systems and methods herein can provide for: obtaining a request for a target model; assigning one or more draft models to the request; assigning one or more cache lines of a key-value (KV) cache to the one or more draft models; for each of a plurality of decoding steps: obtaining a plurality of tokens from the one or more draft models; storing a key-value pair associated with the plurality of tokens in the KV cache; and progressing the KV cache using a cache stepper.

### CROSS REFERENCE TO PRIORITY APPLICATION

The present disclosure claims the benefit of priority of U.S. Provisional Patent Serial Number 63/752,275, titled “SYSTEMS AND METHODS FOR KEY-VALUE CACHING IN SPECULATIVE DECODING,” filed January 31, 2025, the entirety of which is incorporated by reference herein. The present disclosure claims the benefit of priority of U.S. Provisional Patent Serial Number 63/758,162, titled “SPECULATIVE DECODING SYSTEMS AND METHODS HAVING IMPROVED THROUGHPUT,” filed February 13, 2025. The present disclosure claims the benefit of priority of U.S. Provisional Patent Serial Number 63/773,545, titled “SPECULATIVE DECODING SYSTEMS AND METHODS HAVING IMPROVED THROUGHPUT,” filed March 18, 2025. The present disclosure claims the benefit of priority of U.S. Provisional Patent Serial Number 63/767,921, titled “SPECULATIVE DECODING SYSTEMS AND METHODS HAVING IMPROVED THROUGHPUT,” filed March 6, 2025.

### FIELD

The present disclosure relates generally to processors, such as processors for processing tensors. More particularly, the present disclosure relates to systems and methods for key-value caching in speculative decoding.

### BACKGROUND

A tensor is a family of mathematical structures that includes vectors, matrices and higher dimensional arrays. Tensors are used in many fields of science and engineering, and huge tensors with millions to billions of elements are used in numerical calculations such as machine learning. Tensor operations such as multiplication require huge amounts of processing power for large tensors.

Specialized processors for processing tensors have been developed in recent years. One type of a tensor processor is a language processing unit (LPU), such as LPUs sold by Groq Incorporated. Language processing units may comprise a two-dimensional array of functional units (e.g., tiles) organized into a plurality of slices. Each slice is configured to perform specific functions within the processor. Data may flow across the tiles in a first dimension across lanes. Instructions may flow across tiles in a second dimension across slices.

### SUMMARY

Aspects and advantages of embodiments of the present disclosure will be set forth in part in the following description, or can be learned from the description, or can be learned through practice of the embodiments.

In an aspect, the present disclosure provides a method for key-value caching in speculative decoding. The method includes obtaining a request for a target model. The method includes assigning one or more draft models to the request. The method includes assigning one or more cache lines of a key-value (KV) cache to the one or more draft models. The method includes, for each of a plurality of decoding steps: obtaining a plurality of tokens from the one or more draft models; storing a key-value pair associated with the plurality of tokens in the KV cache; and progressing the KV cache using a cache stepper.

In an aspect, the present disclosure provides a computing system. The computing system includes one or more processors and one or more non-transitory, computer-readable media storing instructions that, when implemented, cause the one or more processors to perform operations. The operations include obtaining a request for a target model. The operations include assigning one or more draft models to the request. The operations include assigning one or more cache lines of a key-value (KV) cache to the one or more draft models. The operations include, for each of a plurality of decoding steps: obtaining a plurality of tokens from the one or more draft models; storing a key-value pair associated with the plurality of tokens in the KV cache; and progressing the KV cache using a cache stepper.

In an aspect, the present disclosure provides one or more non-transitory, computer-readable media storing instructions that, when implemented, cause one or more processors to perform operations. The operations include obtaining a request for a target model. The operations include assigning one or more draft models to the request. The operations include assigning one or more cache lines of a key-value (KV) cache to the one or more draft models. The operations include allocating one or more KV cache blocks associated with the assigned one or more cache lines to the one or more draft models. The operations include, for each of a plurality of decoding steps: obtaining a plurality of tokens from the one or more draft models; storing a key-value pair associated with the plurality of tokens in the KV cache; and progressing the KV cache using a cache stepper.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a diagram of a system according to example aspects of the present disclosure.

FIG. 2 illustrates one example transformer model according to example aspects of the present disclosure.

FIG. 3 illustrates a block diagram of an example processor according to some implementations of example aspects of the present disclosure.

FIG. 4 illustrates a block diagram of an example processor according to some implementations of example aspects of the present disclosure.

FIG. 5 illustrates a block diagram of an example processor according to some implementations of example aspects of the present disclosure.

FIG. 6 illustrates a flowchart diagram of an example method according to some implementations of example aspects of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

Large language models (LLMs) are used in generative artificial intelligence applications for a variety of purposes, such as for programming assistants, chatbots, etc. In some LLMs, transformer models may generate words (tokens) based on a prompt and based on previously generated words (tokens) providing context. Furthermore, some transformer models process input data sequentially, generating output tokens one at a time. A challenge for user-facing products is that due to their size, these large models can be slow at inference (i.e., output generation), which may result in an undesirably slow user experience and/or can require significant amounts of memory to store, which may limit their applicability to resource-constrained devices. This latency can arise from the token-by-token generation necessitated by autoregressive decoding, resulting in an escalation of the inference latency with both the length of the generated sequence and the model’s scale.

Furthermore, according to example aspects of the present disclosure, transformer models may use a key-value cache (KV cache) to avoid redundant computations by storing the intermediate results of a self-attention mechanism, namely the key and value vectors, computed during the forward pass for each processed input token. When generating subsequent tokens, the model retrieves and reuses these cached key-value pairs, allowing the model to compute the self-attention for new tokens without recalculating the attention for previously processed tokens.

Dynamic KV cache management may be a tool that improves efficiency in KV cache memory management. For instance, the KV cache can store at least a portion of the context window for a given request to an LLM. One example method for dynamic KV cache management is, for instance, PagedAttention as described in Kwon et al., “Efficient Memory Management for Large Language Model Serving with PagedAttention,” arXiv:2309.06180 (September 12, 2023). In some example methods for dynamic KV cache management, continuous key and value vectors may be stored in non-contiguous blocks in the memory. Each block contains a fixed number of tokens denoted as KV block size. During processing of an input, a KV cache manager may identify and fetch different KV blocks separately for processing. The processor may be configured to multiply a query vector by key vectors in a KV block to obtain an attention score and then later multiply the attention score by the value vectors in a KV block to obtain an attention output. Rather than utilizing a full context length of each cache for each active user, the use of KV cache management provides for segmenting available cache memory into smaller, more manageable blocks. This can allow for each user to begin with a limited number of blocks and dynamically grow the associated cache as more space becomes necessary for the computation of the user.

The throughput of transformer models may be improved by batching requests and processing multiple input sequences in parallel. However, this may require efficient memory management. Since a large part of the memory space for batch processing is associated with the KV cache, inefficient management of the KV cache memory may limit the batch size and throughput of a transformer model.

An emerging inference paradigm referred to as speculative decoding provides reduced latency in some instances. Speculative decoding involves the parallel generation of a plurality of drafted tokens as a speculation of future decoding steps of the target LLM. The target LLM can then be used to verify each drafted token in parallel. Tokens that are successfully verified can be accepted and included in the output of the LLM. One example speculative decoding system can accelerate large model inference by leveraging a combination of small draft models and a large target model. The draft models generate "guess tokens" at a faster rate, while the target model verifies these guesses in parallel, resulting in higher speed and throughput. This system can include a single target model and multiple small draft models, each having its own controller to achieve the overall inference target.

Speculative decoding can improve the applicability of LLM inference compared to a traditional autoregressive configuration. For example, a conventional autoregressive model consumes an output at a first time step as context for generating an output at a second, subsequent time step. Because the autoregressive model is dependent upon a current output for future generation, the autoregressive model is limited in its throughput by the speed of generating tokens in series, with at most one “in-flight” generative task capable of being processed at a time. This limitation is increasingly recognizable in batched systems, where a processor is capable of batching processing among P pipeline stages. In an idealized optimal throughput, each pipeline stage P will be processing a computational task at each time instance. However, in a traditional autoregressive configuration where each generative task is dependent upon prior generative output, it can be challenging to keep each pipeline stage provided with a processing task. For example, for each generative task associated with a distinct output, there may be one token available for processing at a time. To keep each pipeline stage filled with data to be processed may involve providing a number of requests that greatly exceeds the number of pipeline stages, otherwise some stages may be unused, decreasing the throughput of the system below the ideal throughput.

Speculative decoding, however, can decompose the generative tasks of a transformer or other machine-learned model among one or more draft models. The draft models can be relatively lighter weight than the target model used for verifying the generated tokens. This divided generation and verification pipeline can provide for parallelizing token generation and/or improving throughput of generative systems. For instance, each request may generate N tokens in parallel at a given iteration, where N is the number of draft models. Each of these N tokens can be provided to pipeline stages, therefore providing more efficient pipelined processing for the tokens even when the number of requests is nearly equal to or less than the number of pipeline stages. Furthermore, ideal or near-ideal throughput can be achieved with a relatively fewer number of requests, and a relatively fewer number of requests may therefore be loaded in memory when achieving ideal or near-ideal throughput. Consequently, especially in memory-bound systems, the amount of memory needed to achieve ideal or near-ideal throughput can be reduced, thereby reducing the occurrence of potentially detrimental conditions such as eviction or memory unavailability.

As another example, relatively “easy” tokens to generate (e.g., tokens with relatively few potential values or with a relatively high likelihood of taking on a given potential value) can be predicted with less computational overhead, so easier tokens may be allocated to a less resource intensive (e.g., smaller) draft model whereas more challenging tokens may instead be allocated to a more resource intensive (e.g., larger) draft model that is consequently more powerful. As another example, LLM inference may generally be memory bandwidth bound, where the primary bottleneck in generating outputs can arise from storing and/or retrieving data to/from memory. For instance, in some cases, computations and compute cycles may be relatively more available than memory bandwidth. Some hardware tailored to machine-learning, such as language processing units or LPUs (also referred to as “tensor streaming processors” or TSPs), may generally be highly parallelized and capable of orders of magnitude more operations per second than memory bandwidth. By focusing the LLM’s computational efforts on validating pre-drafted tokens rather than generating the tokens themselves, speculative decoding can reduce the frequency of memory operations on LLM parameters and in some cases improve the efficiency of inference operations.

The use of a dynamic KV cache by a speculative decoding system can present a number of challenges. For instance, upon receiving a request from a user, the target model can be tasked with deciding where in the KV cache a request should land and/or which draft model(s) should be allocated to the request and/or to the user. Example aspects of the present disclosure provide solutions for dynamic KV cache management for models utilizing a speculative decoding paradigm. According to example aspects of the present disclosure, a centralized cache manager can account for throughput and output of a plurality of draft models to load balance incoming generative tasks or requests among the plurality of draft models. For instance, the centralized cache manager can recognize if adequate protected memory capacity is available at a particular draft model when assigning a request to the draft model. The centralized cache manager can compare the amount of available memory assigned to a draft model to a maximum memory utilization by each request. For example, in some implementations, the draft models can utilize a sliding window attention configuration, where the context of each request is limited by a sliding window size, and tokens outside of this window are not considered and memory associated with these tokens may therefore be deallocated. In response to an incoming request, the centralized cache manager can determine which of the plurality of draft models has adequate available memory to support being assigned the request. The centralized cache manager can determine which of the identified memory-available subset of draft models to assign the request to by load balancing among the draft models based on a number of active requests on each draft model. For instance, the centralized cache manager can assign requests with the objective of avoiding idle draft models and/or avoiding overwhelming a draft model, which in either case could slow down overall generative tasks.

Furthermore, because one objective of KV caching can be to initially allocate a relatively small amount of memory for a request, such as a block as opposed to an entire cache line, moving through noncongruent user caches can be further complicated by various memory operations and navigations used in speculative decoding, such as progressing through the cache, rewinding the generation in the event of a rejected token, resetting to a particular context, and so on. As another example, in some instances certain caches or portions thereof may be evicted from the KV cache. For instance, eviction may occur in some cases where memory is allocated among a plurality of users in such a manner that enough memory to finish the remaining computations for each user is unavailable, and memory assigned to one user must be (e.g., temporarily) deallocated by “evicting” the user from the KV cache to free up enough memory to complete processing for other users. Eviction can cause users who are evicted to experience slower processing times, and may generally be desirable to avoid where alternatives are available. In some implementations, the evicted tokens may be preserved or stored in another memory location, such as on a hard drive or solid state drive, magnetic tape, or other relatively less frequently accessed storage.

Aspects of the present disclosure provide a number of technical effects and benefits. For instance, aspects of the present disclosure are directed to speculative decoding using dynamic KV caching techniques. Aspects of the present disclosure may support various transformer model techniques such as sliding window attention. The present disclosure can provide for increased throughput of machine-learned models such as LLMs and transformer models. Additionally and/or alternatively, the present disclosure can provide for new computing functionality by providing for the use of dynamic KV caching with speculative decoding techniques. Furthermore, the present disclosure can provide for very high context lengths (e.g., greater context lengths than may be allocated to each user statically) with speculative decoding. The increased context length can in turn provide improved accuracy of model outputs. Furthermore, in implementations with batched token verification, the use of speculative decoding and key-value caching can reduce the number of “void” processing cycles where no generated tokens are available for verification.

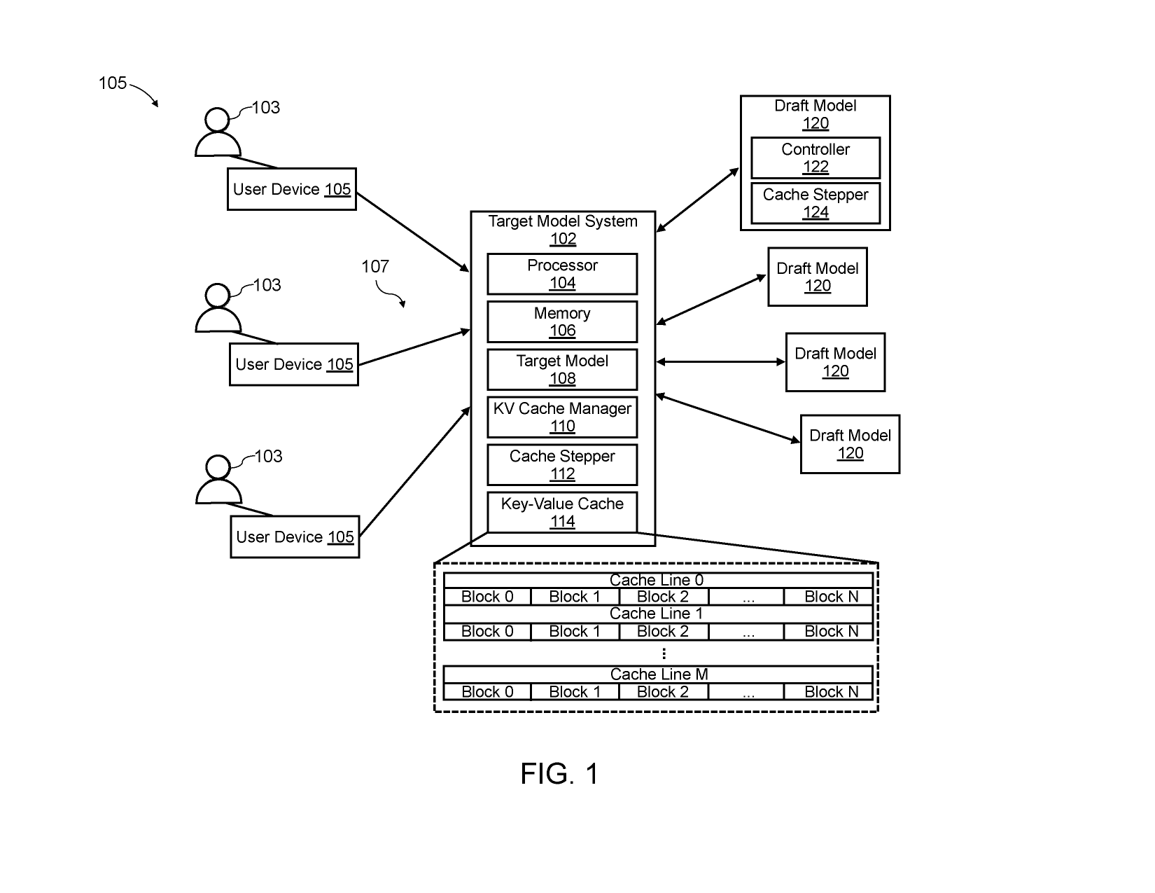

FIG. 1 depicts a speculative decoding system 100 according to example aspects of the present disclosure. The speculative decoding system 100 includes a target model system 102. The target model system 102 can be a computing system, such as a server computing system, datacenter, or other suitable computing system. For instance, the target model system 102 can include a processor 104 and a memory 106. The memory 106 can store computer-readable instructions that, when implemented by the processor 104, cause the processor 104 to perform the operations described herein.

The speculative decoding system 100 can further include a target model 108. The target model 108 can receive requests 107 from user(s) 103 via user device(s) 105. The requests 107 can ask the target model 108 to generate an output or otherwise perform a task relative to the requests. For example, a request 107 may include a phrase of tokens in a plain language, and the users 103 may generally expect an output from the target model 108 that is responsive to the phrase in the request 107. Although FIG. 1 illustrates a single request 107 per user 103, it should be understood that, in some implementations, a user 103 may provide multiple requests 107.

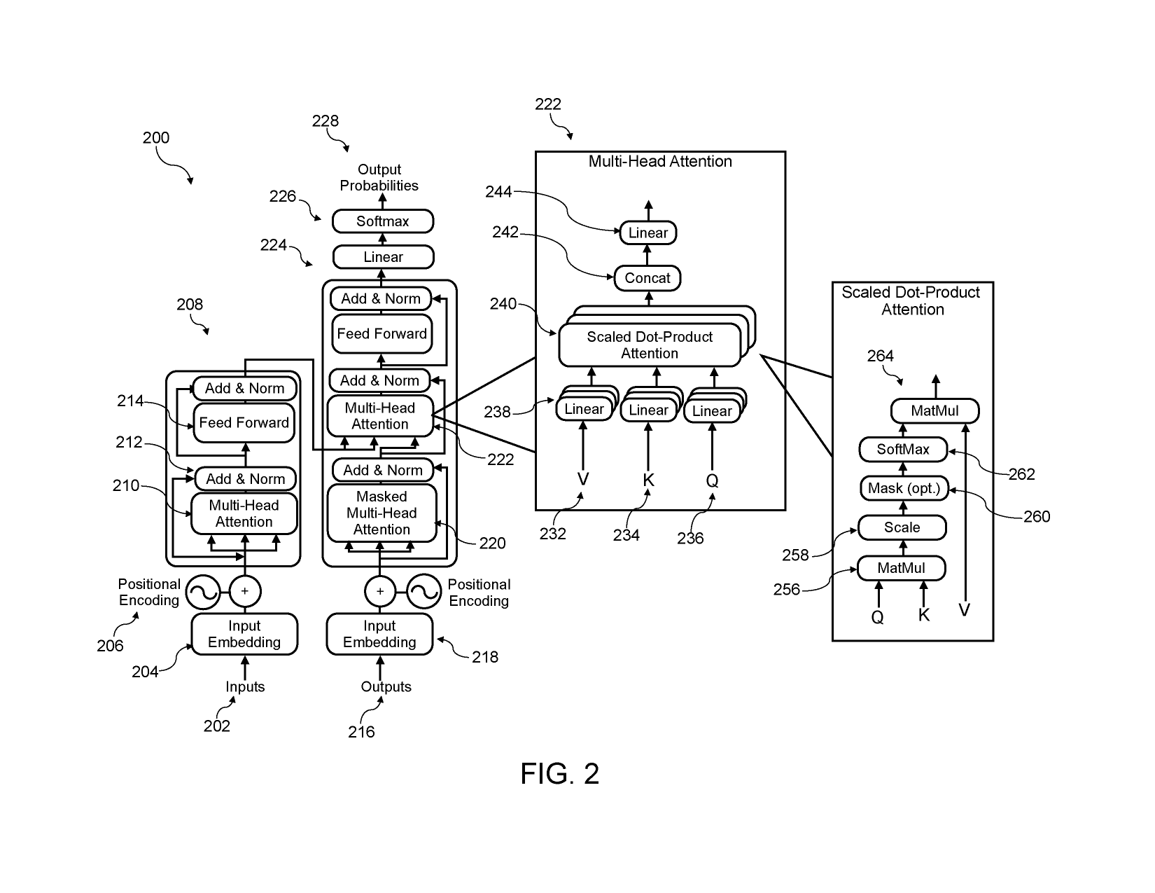

The target model 108 can generate an output including a plurality of tokens. In some implementations, the target model 108 can be a large language model, such as an LLM including one or more transformer models. One example transformer model is depicted in FIG. 2. The target model 108 can be any suitable model utilizing key-value pairs.

FIG. 2 illustrates a transformer model 200 that may be employed as a target model 108 or a draft model 120 within the speculative decoding system 100. The transformer model 200 can receive inputs 202 which are processed to generate an input embedding 204 and combined with a positional encoding 206 to provide the transformer model 200 with information regarding the relative or absolute position of tokens in a sequence. The transformer model 200 includes a stacked structure, where each stack consists of Nx identical layers 208. Within these layers 208, the model utilizes Multi-Head Attention 210, residual connections labeled as Add & Norm 212, and feed forward networks 214 to transform the inputs 202 into generated tokens. The decoder side of the architecture similarly encodes prior outputs 216 into output embeddings 218, which are processed through masked multi-head attention layer 220 and multi-head attention layer 222 before reaching a final linear combination 224 layer and a SoftMax layer 226 to generate a set of output probabilities 228 .

The multi-head attention mechanism 220 provides for the transformer model 200 to jointly attend to information from different representation subspaces at different positions. This process involves projecting the input Values (V) 232, Keys (K) 234, and Queries (Q) 236 through separate linear layers 238. These projections are then processed in parallel by parallel instances of a scaled dot-product attention mechanism 240. The results of these parallel attention heads are combined via a concatenation layer 242 and passed through a subsequent linear layer 244 to produce the final multi-head attention output. As described further herein, a KV cache can be used to store the intermediate keys 234 and values 232 for a given context, which can be used in subsequent processing operations to avoid recomputing the key-value pairs.

The attention scores are computed by performing a matrix multiplication operation 256 of the queries 236 (Q) and keys 234 (K), followed by a scale operation 258 to prevent gradients from becoming too small during training. Depending on the application, a mask operation 260 may be applied before a SoftMax function 262 normalizes the scores. These normalized weights are then applied to the Values (V) 232 through a final MatMul operation 264, which yields a weighted sum as the output of the attention mechanism 220.

Returning to FIG. 1, according to example aspects of the present disclosure, the target model 108 can interface with a plurality of draft models 120 to generate its output. For instance, the target model 108 can orchestrate concurrent generation tasks across the draft models 120. At each decoding step, the target model 108 can obtain draft tokens from the draft models 120. For instance, at each decoding step, each draft model 120 may draft one draft token. In some implementations, however, a single draft model 120 may generate multiple draft tokens per decoding step. The target model 108 can verify the draft tokens from the draft models 120 for inclusion in its output. The target model 108 may also reject a token from a draft model 120. If a token is rejected, the target model 108 may reset to the context of the last accepted token and restart the concurrent generation at the last accepted token, continuing with this process until the output is completed (e.g., if an end-of-response token is predicted). In this manner, the target model 108 may be dedicated to verification of tokens rather than generation of tokens, and the generation of tokens may be parallelized across several draft models 120.

The draft models 120 may be or may include transformer models, such as autoregressive or non-autoregressive transformer models. Furthermore, in some implementations, a variety of model types or model configurations can be used for draft models 120. For example, in some implementations, different draft models 120 may have differing complexities, such as differing numbers of layers, differing parameter values, differing model architectures, or other suitable variations. Some or all of the draft models 120 can include respective controllers 122 to achieve the overall inference target.

According to example aspects of the present disclosure, the target model 108 can utilize a key-value cache 114 (or KV cache 114) to record intermediate results of a self-attention mechanism including key-value pairs. The target model system 102 can further include a key-value (KV) cache manager 110 that manages access to the KV cache 114. The KV cache manager 110 can control each available KV cache block for the target model 108 and/or the draft model(s) 120. The KV cache manager 110 can allocate block-level resources (e.g., the KV cache blocks and/or other supplementing resources) to a request based on various load-balancing heuristics. As one example, if a draft model 120 exhausts its previously allocated KV cache blocks, it can request more memory (e.g., one additional KV cache block) to be allocated to it from the KV cache 114. More particularly, the KV cache manager 110 can determine a number of KV cache blocks to allocate for storing intermediate self-attention results for a particular request. The KV cache manager can determine the number of KV cache blocks to allocate based on various factors, including system-wide factors and/or factors specific to a draft model. The KV cache manager can provide efficient resource utilization and mitigate conflicts between concurrent users 103 and/or requests. Furthermore, the KV cache manager 110 can load-balance generative tasks associated with requests 107 by assigning draft models 120 to requests 107 based on factors such as a number of active requests associated with a draft model 120 and/or memory utilization of the draft models 120.

In one example implementation depicted in FIG. 1, the KV cache 114 can include a number of cache lines. Each cache line may include a plurality of KV cache blocks. Furthermore, each KV cache block can reference a number of indexes (e.g., memory addresses, such as byte-level addresses) in a memory (e.g., the memory 106 or another suitable memory) storing the KV cache 114. Each KV cache block can be used to store a key-value pair associated with one or more tokens from the draft models 120. In some implementations, the KV cache blocks may map directly to memory addresses. For example, a block identifier of a KV cache block may be or may directly correspond to a memory address. In some implementations, the KV cache blocks may have some other (e.g., logical) mapping between block identifiers and memory addresses. In some implementations, the KV cache blocks may be divided between memory functional units (MEM units) of various language processing units.

In some implementations, each user 103 may initially be assigned a single cache line in the KV cache 114 such that the user 103 may only be allocated KV cache blocks from the respective assigned cache line of the user 103. For instance, a first user 103 may be assigned to cache line 0 and a second user 103 may be assigned to cache line 1 in the KV cache. The first user 103 may not be allocated any KV cache blocks from cache line 1, and the second user 103 may not be allocated any KV cache blocks from cache line 0. Multiple users 103 may be assigned to a single cache line and share KV cache blocks from the cache line as needed. The use of cache lines can provide for reducing fragmentation within the memory of the KV cache by concentrating memory allocation for a single user within a particular area of memory defined by the cache line. Furthermore, a cache line can provide a maximum bound on the amount of memory that may be allocated for a context length of a particular request, thereby preventing computing resources assigned to the request from ballooning indefinitely.

According to example aspects of the present disclosure, a draft model 120 can further be assigned to a user 103 and consequently to a particular cache line of the KV cache 114. For instance, the KV cache manager 110 can define a relationship between a request or user, a draft model 120, and a cache line of the KV cache 114.

In some implementations, the KV cache manager 110 can determine whether to allocate additional KV cache blocks to a request based on present load data respective to draft models 120 assigned to the request. The present load data can include a number of concurrent users assigned to a particular draft model 120. For instance, a draft model 120 may concurrently handle multiple requests at a time, such as by swapping between outputting tokens for different requests at each new generation cycle. As one example, the draft model 120 may generate tokens for one request while the target model 108 is validating tokens for another request. While a single target model 108 may handle requests for each user 103, it is possible that some requests will be assigned to only a subset of all available draft models 120, such that the number of users 103 (or requests) assigned to a draft model 120 is less than a total number of users 103 submitting requests to the target model 108. The KV cache manager 110 can assign requests to particular draft models 120 to load-balance the active users on the draft models 120 system-wide. For instance, if too many users 103 are assigned to a single draft model 120, the draft model 120 may become processor-bound on token generation due to the requirement of cycling through users 103.

Additionally and/or alternatively, the present load data can include an amount of memory remaining or, similarly, a total amount of previously allocated memory available for a given draft model 120. For example, the number of KV cache blocks allocated for a given request can be limited by a number of blocks remaining in the cache lines allocated to a particular draft model 120.

In some implementations, the allocation and/or eviction of KV cache blocks can further be based on request-specific attributes. One example request-specific attribute is prompt length or request length. Intuitively, a shorter prompt seeds a transformer model with fewer initial tokens, thereby building a relatively less intensive context length compared to a similar prompt having a longer length. Therefore, it could be less expensive to recompute the context length of a shorter prompt than that of a longer prompt. Additionally, the shorter prompt may require less capacity to store its context length. If prompt lengths are unevenly distributed across all requests on a draft model 120, it can be beneficial to consider the prompt lengths in allocating memory. For example, if the prompts tend to be longer (e.g., whether by design such as by the workload the target model 108 is intended for or whether by monitoring prompt length at a given point in time), eviction may be discouraged due to the relatively high cost of recomputing context length once the evicted tokens are returned to the KV cache 114 at a later point. Alternatively, if the prompts tend to be shorter, capacity savings from eviction may be prioritized over the relatively lower cost of recomputing context length.

The system 100 can further include cache steppers 112 at the target model 108 and cache steppers 124 at the draft models. The cache steppers 112, 124 are responsible for managing local usage of cache blocks in the KV cache 114 allocated by the cache manager 110. The cache steppers 112 and 124 can be coordinated and can correspond to a particular active user. The cache steppers 112 and 124 can request additional KV cache blocks from the cache manager 110 as needed. Additionally and/or alternatively, the cache steppers 112 and 124 can deploy stepping logic to navigate the allocated KV cache blocks and execute the selected speculative decoding algorithm. This deployed logic can be related to the type of key-value cache utilized. As one example, the stepper logic for “vanilla” KV caching can include a fixed context length is specified and upon reaching the end of the context length, the computation is paused at the last available context length. As another example, the stepper logic for sliding window attention KV caching can overwrite context of earlier tokens within the KV cache 114 upon reaching the end of its context length to provide for computations of length that exceeds the allocated memory. For example, assuming a content length of some arbitrary number of tokens, such as 4192 tokens, the sliding window attention KV caching logic will compute 4192 tokens using standard KV caching and attempt to request another KV cache block. If the cache stepper 124 is unable to obtain more space in the KV cache 114, the cache stepper 124 will navigate back (e.g., “wrap-around”) to an earlier point in the KV cache 114 and begin to overwrite the earlier context with context for new tokens. Some contexts can be prioritized relative to others. For instance, in some cases, the context entries earlier in the KV cache may be higher priority contexts for caching. These contexts may be, for example, the prompt itself and/or some of the most closely related contexts. The cache stepper 124 may therefore begin overwriting contexts that are later than the earliest contexts (e.g., some number of positions after the first contexts).

In some implementations, a communications protocol can provide seamless interactions between the cache steppers 124 of the draft models 120, the cache manager 110 of the target model 108, and/or additional components in the system 100. The communications protocol can define request and response mechanisms for allocating/deallocating KV cache blocks, special requests for canceling active requests and releasing resources to prevent conflicts, rewinding the computation in the event of a rejected token and/or resetting the context using the KV cache 114 as necessary, and so on.

Upon detecting a mismatch between a golden token or golden label and the token produced by a draft model 120, the target model 108 can inform the draft model(s) 120 and/or the head of the target model 108 using the communications protocol. For instance, the target model 108 can communicate a position of the mismatched token and/or an indication of what the token should have been (e.g., the golden token). The target model 108 can communicate a sequence of tokens (e.g., a burst request) to the draft model(s) 120 that conveys a token or set of tokens and a position such that the draft model(s) 120 can continue generating tokens starting at or after the position and based on the communicated token(s). The cache steppers 112/124 can then calculate where in the KV cache 114 to return to based on the communicated position. In a sliding window attention KV cache, this may include wrapping around back to the end (or another non-congruous) position within the KV cache 114. For example, in the event of a wrap-around, the cache stepper 112/124 may record an address or pointer to the last position before the wrap-around to facilitate this rewind operation, which can facilitate speculative decoding. In some cases, only a subset of generated tokens may actually be verified by the target model 108. In these cases, the KV cache may be rewound to the last verified token, rather than the mismatched token.

In some implementations, the target model 108 may also initiate a refill request. The refill request may be performed before any additional verifications. In response to the refill request, the target model system 102 can reset to the point where the last accepted token was accepted, discarding any “incorrect” tokens that came afterward.

Example aspects of the present disclosure may be implemented using one or more processors, such as language processing units, FPGAs, ASICS, etc. An example language processing unit will be discussed in detail below for purposes of illustration and discussion. However, those of ordinary skill in the art, using the disclosures provided herein, will understand that aspects of the present disclosure may be implemented using any suitable processor, processing circuitry, or the like without deviating from the scope of the present disclosure.

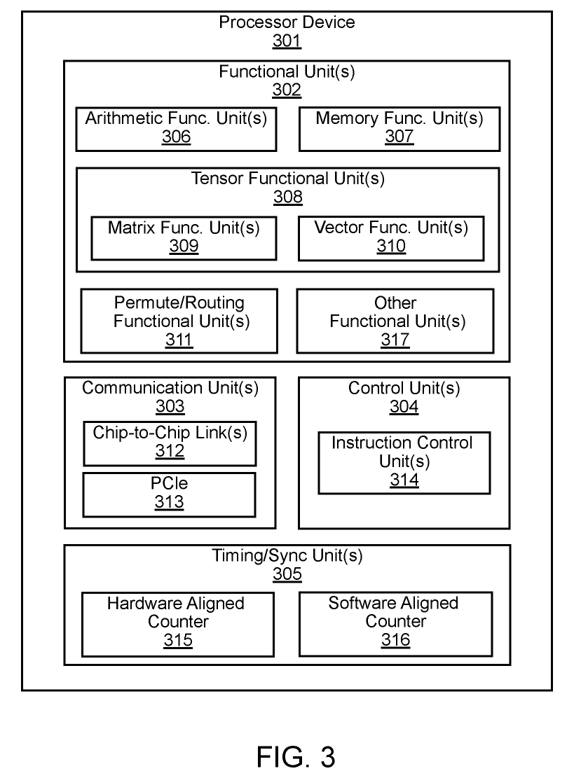

FIG. 3 is a block diagram of an example processor device 301 according to example implementations of aspects of the present disclosure. The processor device 301 can include one or more functional units 302; one or more communication units 303; one or more control units 304 (e.g., instruction control unit(s) 314, etc.); one or more timing or synchronization units 305; or other components. In some instances, functional unit(s) 302 of the processor device 301 can include one or more of: arithmetic functional unit(s) 306; memory functional unit(s) 307; tensor functional unit(s) 308 (e.g., matrix functional unit(s) 309, vector functional unit(s) 310, etc.), permute or routing functional units 311, or other functional units 317. Communication unit(s) 303 can include, for example, one or more of chip-to-chip communication link(s) 312, peripheral component interconnect express 313 components, or other communication unit(s) 303. Timing and synchronization units 305 can include, for example, one or more hardware-aligned counters 315, one or more software-aligned counters 316, or other timing or synchronization component.

A processor device 301 can include various types of processor architectures. In some instances, a processor device 301 can include a single-core or multi-core processor device 301. In some instances, a processor device 301 can include an integrated circuit located on a single die or a processor device 301 distributed over multiple dies connected together (e.g., directly connected such as via face-to-face connection, indirectly connected such as via one or more interposers, etc.). In some instances, a processor device 301 can include one or more of: one or more field programmable gate arrays (FPGAs); one or more application-specific integrated circuits (ASICs), such as ASICs for machine-learned inference, matrix multiplication, floating-point operations, or the like; one or more graphics processor units (GPUs); one or more tensor processing devices; or other processor type. In some instances, a processor device 301 can include a deterministic processor device or a non-deterministic processor device (e.g., processor device configured to operate according to a deterministic or non-deterministic timing, etc.). In some instances, a processor device 301 can include a processor device having a plurality of dedicated special-purpose functional units, or a processor device having one or more general-purpose functional units (e.g., multi-core processor having a plurality of general-purpose processor cores, etc.). For example, in some instances, a processor device 301 can include a single-core processor device 301 having a plurality of special-purpose functional units 302 having distinct functions, such as functional units 302 having distinct instruction set architectures.

In some instances, a processor device 301 can include a deterministic processor device. A deterministic processor device can include, for example, a processor device configured to perform a plurality of operations according to a predetermined order, such as a predetermined program order defined by a compiler. In some instances, a deterministic processor device can include a processor device configured to perform a plurality of operations according to a predetermined timing or according to a predetermined temporal relationship between operations. For example, in some instances, a deterministic processor can include a processor configured to receive one or more computer-executable instructions (e.g., compiled instructions, etc.) comprising timing data; and execute the instruction(s) according to a predetermined time or predetermined temporal relationship indicated by the timing data. Timing data can include, for example, one or more of: data indicative of a clock cycle on which to execute a particular operation; data indicative of a temporal relationship between one or more first operations and one or more second operations, such as data indicative of a number of clock cycles to pause after a first operation (e.g., data transfer operation, instruction transfer operation, floating-point operation, etc.) is completed before performing a second operation (e.g., floating-point operation, tensor processing operation, etc.); data indicative of one or more operations or instructions configured to have an effect on a timing of operations, such as data indicative of one or more no-operation (NOP) operations or sleep operations, such as a repeated-NOP instruction to cause a functional unit 302 or other component of a processor device 301 to remain idle for a predetermined number of clock cycles; or other timing data.

In some instances, a deterministic processor device can include a processor device configured to receive, from a compiler, a set of computer-executable instructions controlling a timing of a plurality of operations associated with the computer-executable instructions; and perform the plurality of operations according to the timing. For example, in some instances, a deterministic processor device can include a processor device configured to receive a compiled program configured to cause, for each respective operation of a plurality of operations (e.g., arithmetic operations such as floating-point operations, tensor operations, etc.) to be performed on one or more respective data operands (e.g., numerical operands such as machine-learned model parameters, activation values, etc.), an instruction associated with the respective operation to intersect with the respective data operand at a predetermined time instant (e.g., clock cycle, clock cycle offset relative to an initial clock cycle, etc.) defined in the compiled program. In some instances, a deterministic processor can include a processor device having one or more components (e.g., functional unit(s) 302, communication unit(s) 303, etc.) having an instruction set architecture comprising instructions to control a timing of one or more operations of the one or more components.

In some instances, a deterministic processor device 301 can include a processor device configured to route data between functional units 302 of the processor device 301 according to a predetermined timing, predetermined routing or pathing, or both. For example, in some instances, a deterministic processor device 301 can include a processor device configured to receive compiled instructions comprising data indicative of one or more data transfer operations to be performed according to one or more predetermined routes determined by a compiler, according to one or more predetermined timing values defined by the compiler, or both. In this manner, for instance, a deterministic processor device 301 can enable a compiler to perform compile-time load balancing for a plurality of data paths, and can execute a plurality of runtime data transfers according to the compile-time load balancing.

In some instances, a deterministic processor device 301 can include a processor that lacks one or more non-deterministic components that may be commonplace among non-deterministic processor devices, such as branch prediction units, tiered or hierarchical cache devices, runtime load balancing, or other sources of runtime non-determinism (e.g., non-deterministic timing of operations, non-deterministic choice of operations such as non-deterministic routing of data, etc.). For example, in some instances, a processor device 301 can lack any branch prediction components, and can be configured to execute every operation of a compiled program according to a predetermined program order. As another example, in some instances, one or more memory functional units 307 can lack a cache hierarchy or lack any non-deterministic memory component(s). For example, in some instances, one or more memory functional units 307 can be configured to operate deterministically, such as according to a predetermined timing defined by a compiler. For example, in some instances, one or more memory functional units 307 can be configured to perform one or more read operations at one or more times predetermined by a compiler; perform one or more write operations at one or more times predetermined by the compiler; perform one or more refresh operations at one or more times predetermined by the compiler, such that the compiler can have explicit control over a refresh timing of the memory functional unit(s) 307; or the like. For example, in some instances, the compiler can compile a program or other executable into a set of deterministic operations that can be executed by the functional unit(s) 302 at known times specified by a deterministic schedule.

However, although a deterministic processor device 301 can lack some common sources of non-determinism, in some instances, a deterministic processor device 301 can include or interact with one or more non-deterministic components or devices without deviating from the scope of the present disclosure. As a non-limiting illustrative example, in some instances, a deterministic processor device 301 can include a PCIe 313 component configured to perform external input/output (I/O) operations, which can in some instances include input/output operations having a non-deterministic timing (e.g., I/O operations using a non-deterministic PCIe 313 device; I/O operations receiving input from non-deterministic external device(s); etc.). In some instances, a deterministic processor device 301 can interact with non-deterministic component(s) or device(s) (e.g., components or devices internal or external to the processor, etc.), while maintaining deterministic operation of the remaining components of the processor device 301 by designating one or more predetermined time windows to interact with the non-deterministic component(s) in a deterministic manner. For example, in some instances, a processor device 301 can be configured to check, at each of a plurality of predetermined times, whether one or more inputs (e.g., inference request(s), etc.) has been received via a PCIe device 313; and, if the processor device 301 determines that an input has been received, to process the input (e.g., write the input to a designated memory location or region, etc.) according to a predetermined timing or predetermined set of instructions (e.g., according to a set of operations configured to fit within a predetermined time window reserved for non-deterministic external I/O operations, etc.).

In some instances, a processor device 301 can include a processor device configured for single-instruction multiple-data (SIMD) operation. For example, in some instances, a processor device 301 can be configured to receive one or more computer-executable instructions that are each indicative of an operation to be performed on a plurality of operands, such as a vector of numerical operands; a tensor of numerical operands; or the like. In some instances, a SIMD processor device can include a processor device configured to provide a single instruction to a plurality of functional units 302 (e.g., adjacent functional units 302 arranged in a functional region, etc.) to cause each respective functional unit 302 of the plurality of functional units 302 to execute the instruction on one or more distinct operands provided to the respective functional unit 302 (e.g., routed to the respective functional unit 302 according to a predetermined compiler-defined routing, etc.).

In some instances, a processor device 301 can include a single-core processor device, or a processor device configured to operate as a single-core device (e.g., flexible-operation processor device having two hemispheres that can be operated in series as a single-core device or in parallel as a multi-core device, etc.). For example, in some instances, a single-core processor device can include a processor device configured to receive a single set of instructions (e.g., compiled instructions, etc.) and to execute, in a serial or pipelined fashion using one or more functional units 302, a set of operations defined by the single set of instructions. For example, in some instances, a single-core processor device 301 can include a processor device configured to obtain (e.g., receive, retrieve, etc.) one or more instructions (e.g., SIMD instructions, etc.) indicative of a plurality of operations (e.g., plurality of SIMD operations, etc.) to be performed on one or more operands; and perform, in series using a plurality of functional units 302, the plurality of operations (e.g., SIMD operations wherein each operation is a multiple-data operation, etc.) on the one or more operands.

Functional unit(s) 302 can include, for example, one or more components (e.g., integrated circuit components, etc.) configured to perform operations on one or more operands (e.g., data operands, etc.). In some instances, functional unit(s) 302 can include deterministic functional units 302, such as deterministic functional units configured to perform one or more operations in a predetermined program order, according to a predetermined timing or temporal relationship, or the like. In some instances, a set of functional units 302 can include a plurality of dedicated or special-purpose functional units 302, such as distinct functional units 302 having distinct functions or sets of functions (e.g., limited or specialized function sets, etc.). In some instances, functional unit(s) 302 can include functional units configured to perform multiple operations per instruction for at least some instructions, such as single-instruction multiple-data (SIMD) functional unit(s) 302, and/or functional unit(s) 302 configured to process instruction(s) directed to multiple computing operations (e.g., multiple repetitions of a single type of operation, pipeline of multiple different operations, etc.).

In some instances, a set of dedicated functional unit(s) 302 can include distinct dedicated functional units 302 for each of a plurality of steps in a machine-learned inference pipeline, such as a distinct dedicated functional unit for each component of a category or type of machine-learned model layer (e.g., convolutional layer, attention layer, fully connected layer, etc.). For example, in some instances, a set of dedicated functional units 302 for implementing a fully connected layer of a machine-learned model can include one or more matrix functional units 309 for performing matrix multiplication between a parameter tensor (e.g., weight matrix, etc.) and a tensor (e.g., vector, etc.) of input values to the fully connected layer, and one or more vector functional units 310 for performing an activation function of the fully connected layer. As another example, in some instances, a set of dedicated functional units 302 for implementing a convolutional layer of a machine-learned model can include one or more permute/routing functional units 311 configured to perform one or more data reshaping operations corresponding to one or more convolutions (e.g., two-dimensional convolutions, one-dimensional convolutions, etc.); and one or more other functional units 302 (e.g., matrix functional unit(s) 309, vector functional unit(s) 310, etc.) for performing additional operations associated with a convolutional layer or convolutional neural network (e.g., matrix multiplication, pooling, activation functions, etc.).

In some instances, a plurality of dedicated functional units 302 can include a first functional unit 302 configured to perform a set of operations that is different (e.g., completely disjoint from or partially overlapping, etc.) from a second set of operations associated with a second functional unit 302. In some instances, a plurality of special-purpose or dedicated functional units 302 can have a plurality of distinct instruction set architectures, such as limited or special-purpose instruction set architectures each supporting a limited or special-purpose set of operations. As a non-limiting illustrative example, in some instances, a set of dedicated functional units 302 can include one or more of: a matrix functional unit 309 configured to perform a first set of matrix operations (e.g., matrix multiplication operations, etc.); a vector functional unit 310 configured to perform a set of vector operations different from the matrix operations (e.g., activation function operations such as rectified linear unit (ReLU), sigmoidal, softmax, or other activation function operations; normalization operations; etc.); a permute/routing functional unit 311 configured to perform one or more data routing, data permutation, or data reshaping functions (e.g., tensor permutation or reshaping, etc.) different from the matrix operation(s) and different from the vector operation(s); or other dedicated functional unit(s) 302. Other examples are possible.

In some instances, functional unit(s) 302 can include functional units organized into functional regions of a processor die, such as compact functional regions configured to facilitate low-latency propagation of instructions or operands within a functional unit 302 or between adjacent functional units 302. As a non-limiting illustrative example, in some instances, one or more functional units 302 can be organized into functional groups along a first axis of a processor die, thereby enabling low-latency propagation of one or more instructions along the axis, low-latency propagation of operand data along a second axis, or the like. Further details of an example processor device comprising functional groups are provided below with respect to FIG. 3.

In some instances, functional unit(s) 302 or functional region(s) can be geographically organized on a processor die to reduce (e.g., minimize or nearly minimize; reduce relative to a random arrangement or relative to a conventional multi-core central processing unit or conventional graphics processing unit, etc.) a communication cost (e.g., latency cost, power cost, communication distance, etc.) associated with one or more computational pipelines, such as machine-learned inference pipelines. For example, in some instances, one or more functional units 302 or functional regions of a processor device 301 for performing a sequentially first operation in a computational pipeline can be geographically close to one or more functional units 302 for performing a sequentially second operation in the computational pipeline. Example computational pipelines can include, for example, inference pipelines associated with common machine-learned model, layer, or head architectures, such as convolutional architectures; attention architectures; fully connected layer architectures; selective structured state space machine architectures; gating architectures (e.g., long short-term memory, etc.); or another machine learning architecture.

In some instances, functional unit(s) 302 can include functional units configured to perform multiple operations per instruction for at least some instructions, such as single-instruction multiple-data (SIMD) functional unit(s) 302 or functional units 302 configured to operate without necessarily receiving explicit instructions for each operation. For example, functional unit(s) 302 configured to operate without necessarily receiving explicit instructions for each operation can include one or more of: functional unit(s) 302 configured to receive intermittent instructions and perform multiple operations per instruction (e.g., repeated single operation, pipeline of multiple different operations, etc.); functional unit(s) 302 configured to operate without instructions according to a default operation; or the like. In this manner, for instance, an amount of communication required to provide instructions to the functional units 302 can be reduced, and operation of the processor device 301 can in some instances be simplified compared to some alternative implementations.

For example, in some instances, a SIMD functional unit 302 can include a tensor functional unit 308 configured to execute an instruction on a plurality of numerical values, such as a vector or matrix of numerical values. For example, in some instances, a tensor functional unit 308 can be configured to receive an instruction; and process, according to the instruction, a tensor (e.g., one-dimensional vector tensor, two-dimensional matrix tensor, etc.) comprising a plurality of numerical values (e.g., dozens of numerical values per instruction, such as hundreds, such as 320 numerical values in some examples described below with respect to FIG. 3). In some instances, a tensor functional unit 308 can be configured to process some or all of a plurality of values simultaneously, or to execute a single-instruction multiple-data instruction according to a staggered timing.

As another example, in some instances, a functional unit 302 configured to operate based on intermittent instructions can include a functional unit 302 configured to repeat one or more operations, such as a functional unit 302 configured to continue performing a given operation (e.g., an operation associated with a most recently received instruction, etc.) periodically (e.g., at every clock cycle; at every Nth clock cycle; etc.) for some amount of time (e.g., indefinitely, for a finite period of time such as a time period defined by a previously received instruction, etc.) in the absence of explicit instructions. In some instances, a functional unit 302 can include a functional unit 302 configured to receive and execute one or more repetition instructions (e.g., having an instruction set architecture comprising one or more repetition instructions, etc.). A repetition instruction can include, for example, an instruction to cause the functional unit 302 to repeat (e.g., repeat at every clock cycle; at every Nth clock cycle, where N can be a parameter of the instruction; etc.) a previous instruction or set of instructions a number of times specified by the instruction; an instruction indicative of an operation to be repeated (e.g., arithmetic operation, matrix operation, vector operation, etc.), the instruction having a repetition parameter indicating a number of times to repeat the operation; or the like. In some instances, a repetition instruction can include one or more offset parameters, such as a time offset parameter (e.g., number of cycles to wait between repetitions, etc.), location offset parameter indicative of a distance between consecutive locations (e.g., functional unit 302 location, memory location, data path location, etc.) associated with a repeated operation, or other offset parameter.

As another example, in some instances, a functional unit 302 can include a functional unit 302 configured to receive a single instruction indicative of multiple distinct operations to be performed on a single operand or set of operands, such as a multiply-accumulate (MACC) instruction or matrix multiplication instruction indicative of one or more multiply operations and one or more accumulate operations to be performed on one or more outputs of the multiply operation(s). In some instances, a functional unit 302 can include a pipelined hardware architecture (e.g., systolic array pipelined hardware, deterministic streaming hardware such as hardware having one or more properties described with respect to FIG. 3, etc.) configured to provide (e.g., directly; indirectly via one or more buffers, registers, or other memory components; etc.) an output of one or more first hardware devices (e.g., floating-point units, etc.) for performing earlier (e.g., sequentially first, etc.) operations of a multi-operation instruction to an input of one or more second hardware devices for performing later (e.g., sequentially second or last, etc.) operations of the multi-operation instruction. In some instances, a pipelined hardware architecture of a functional unit 302 can include a geographically compact architecture, wherein a plurality of components for performing a multi-operation instruction can be adjacent or otherwise close together on a processor die.

An arithmetic functional unit 306 can include, for example, one or more functional units 302 for performing various arithmetic operations, such as floating-point operations, integer operations, or quantized operations; simple operations (e.g., add, multiply, format conversion, etc.) or complex/combined operations (e.g., multiply-accumulate, etc.); single-operand operations or multi-operand operations (e.g., tensor operations, etc.); or other arithmetic operations. In some instances, an arithmetic functional unit 306 can be a tensor functional unit 308 or component thereof, or have one or more properties described below with respect to tensor functional unit(s) 308.

A memory functional unit 307 can include, for example, one or more functional units 302 for reading, writing, or storing various kinds of data, such as operand data, instruction data, or other data. Data storage can include, for example, temporary storage of one-time-use or ephemeral values (e.g., computed operand values, etc.), longer-term storage of values to be reused (e.g., machine-learned model weights, compiled computer-executable instructions, etc.), or other storage. In some instances, a memory functional unit 307 can include one or more low-latency, high-bandwidth, or otherwise rapidly accessible memory devices, such as random access memory (RAM) devices (e.g., static random access memory (SRAM), high-bandwidth memory (HBM), dynamic random access memory (DRAM), etc.), registers, or other low-latency devices.

In some instances, one or more memory functional units 307 can be configured to share a global address space accessible to a plurality of functional units 302. For example, in some instances, a global address space can include all memory locations available to the processor device 301 (e.g., including any external memory modules, etc.), such that any functional unit 302 of the processor device 301 can obtain (e.g., receive at a predetermined time defined by the compiler, such as without requiring the functional unit 302 to output any request for the data obtained). In some instances, a set of memory functional unit(s) 307 can include, or a processor device 301 can have access to, one or more internal (e.g., on-chip) memory functional units 307; one or more external (e.g., off-chip, near-compute, etc.) memory units; or both. Further details of some example near-compute external memory units are provided below with respect to FIG. 2, while details of some example on-chip memory units are provided below with respect to FIG. 3.

A tensor functional unit 308 can include, for example, a functional unit 302 to perform one or more operations (e.g., arithmetic operations such as tensor multiplication, elementwise multiplication, normalization, activation function operations, etc.) on one or more tensors (e.g., matrices, vectors, etc.). In some instances, a tensor functional unit 308 can include a matrix functional unit 309; a vector functional unit 310; or another functional unit.

A matrix functional unit 309 can include, for example, a functional unit 302 configured to perform one or more operations on a matrix (e.g., two-dimensional matrix, flattened matrix, etc.) of operands (e.g., numerical values such as floating-point values, etc.). In some instances, a matrix functional unit 309 can include a functional unit 302 configured to perform matrix multiplication or other matrix operations.

A vector processing unit 310 can include, for example, a functional unit 302 configured to perform one or more operations on a vector (e.g., one-dimensional vector, flattened tensor, etc.) of operands (e.g., floating-point numerical values, etc.). In some instances, a vector processing unit 310 can include a functional unit 302 configured to perform one or more of: one or more activation function operations (e.g., sigmoidal or logistic activation function, linear unit activation function such as rectified linear unit (ReLU), softmax activation function, etc.), one or more normalization operations (e.g., L2 normalization, etc.), one or more combining operations (e.g., attention-based combining, etc.) to combine a set (e.g., pair, trio, etc.) of vectors, one or more constituent operations configured to be combined to support a class of related operations (e.g., class or category of normalization operations, class or category of activation function operations, etc.), or the like.

A permute/routing functional unit 311 can include, for example, a functional unit 302 configured to perform one or more data permuting or data routing operations. In some instances, a data permuting operation can include one or more swap or reordering operations configured to reorder data in an ordered format (e.g., vector format or other tensor format; ordered arrangement of registers, signal lines, or other hardware units; etc.), such as without changing a shape (e.g., length, width, number of dimensions, etc.) of the ordered format. Example reordering operations can include, for example, rotation or translation operations; arbitrary reordering operations defined by one or more reordering maps such as a gather map; or other reordering operations. In some instances, a data permuting operation can include a reshaping operation, such as a reshaping operation changing a number of dimensions of a data structure (e.g., tensor, hardware devices corresponding to a tensor, etc.), changing a size of one or more dimensions of the data structure, or the like. As a non-limiting illustrative example, in some instances, a reshaping operation can include a tensor flattening operation to convert a multi-dimensional tensor into a one-dimensional data structure (e.g., vector, hardware configuration corresponding to a vector, one-dimensional data stream corresponding to a vector, etc.). As another example, in some instances, a reshaping operation can include an expansion or duplication operation, such as a reshaping operation to generate an expanded convolutional kernel to implement a filter component of a convolutional neural network. In some instances, a routing operation can include a permuting operation to change an ordering of operands input to one or more fixed or predetermined data paths, or another routing operation (e.g., switching operation; pair of operations comprising a send and a receive; etc.). In some instances, a permuting operation can include a routing operation to change a routing of operands to hardware having a fixed or predetermined input order.

In some instances, a memory functional unit 307; a tensor, matrix, or vector functional unit 308, 309, 310; or a permute/routing functional unit 311 can be or include a deterministic functional unit 302 configured to execute instruction(s) at a predetermined time defined by a compiler; a single-instruction multiple-operation functional unit 302 configured to perform a plurality of operations based on one instruction; or have any other property described herein with respect to functional unit(s) 302. Further details of some example functional units 307, 309, 310, 311 are provided below with respect to FIG. 3.

Communication units 303 can include various components for performing communication operations (e.g., input, output, etc.) between the processor device 301 and other devices (e.g., processor devices, computing devices, external memory devices, etc.) or components, or within the processor device 301. In some instances, communication units 303 can include deterministic communication units (e.g., communication units performing operations according to a predetermined program order, timing, temporal relationship, or other predetermined property, etc.), non-deterministic communication units (e.g., communication units having non-deterministic timing properties, communication units configured to communicate with non-deterministic external devices, etc.), or both. For example, in some instances, a deterministic processor device 301 can include a plurality of deterministic chip-to-chip communication links 312 configured to communicate with other deterministic processor devices 301 (e.g., using deterministic communication operations having a predetermined timing, communication path, or other property), along with one or more PCIe components 313 configured to interact with one or more non-deterministic components. In some instances, communication units 303 can include or have access to various components, such as serializer-deserializer (SerDes) units configured to serialize data to be output or deserialize data received as input; communication ports, connections, interface units, or the like; communication lines (e.g., electrically conductive signal traces, electrically conductive wires, optical fibers, cables, etc.); routing or data permutation components (e.g., internal routing or permutation components such as switching components; external components coupled to the processor device 301 such as routers, repeaters, switches, panels, or the like); or other components configured to facilitate one or more communication operations.

Chip-to-chip communication units 312 can include, for example, any device or component for communicating with another processor device (e.g., processor device 301, etc.), such as one or more serializer-deserializer units, one or more communication channels (e.g., signal lines, etc.), one or more connection components (e.g., ports, pins, connection pads, etc.), or the like. In some instances, a processor 301 can include a plurality of chip-to-chip communication ports to facilitate direct communication with a plurality (e.g., four, eight, sixteen, etc.) of other chips, such as according to a high-radix chip-to-chip communication topology (e.g., dragonfly topology, hyperX topology, etc.), such as a topology having greater than or equal to eight chip-to-chip communication links per processor device 301. In some instances, chip-to-chip communication units 312 can include units configured to communicate with processor devices that are geographically close to or far away from the processor device 301 (e.g., in a same or different compute node as the processor device 301; in a same or different rack; etc.). In some instances, chip-to-chip communication units 312 can include connections to a plurality of distinct chips, a plurality of connections to a single chip, or both. In some instances, chip-to-chip communication units 312 can include chip-to-chip communication units 312 associated with one or more bidirectional communication channels, one or more unidirectional communication channels, or both. In some instances, chip-to-chip communication units 312 can include deterministic communication units configured to perform chip-to-chip communication operations (e.g., send operation, receive operation, etc.) at one or more times predetermined by a compiler; deterministic communication units having a known or deterministic timing for one or more data transfer operations; or the like. In some instances, one or more timing units 305 can be used to provide synchronization for one or more processor devices 301 to facilitate deterministic-timing communication between chips.

A peripheral component interconnect express (PCIe) component 313 can include, for example, a communication device configured to facilitate communication between a processor device 301 and one or more other devices (e.g., computing devices; processor devices; data storage devices; auxiliary devices; etc.). In some instances, a PCIe unit 313 can include a communication system conforming to one or more PCIe communication standards (e.g., PCIe 6.0, PCIe 3.0, etc.). Although FIG. 3 depicts a PCIe unit 313, other communication units or communication standards can be used without deviating from the scope of the present disclosure. In some instances, a processor device 301 can include a deterministic processor device 301 configured to communicate non-deterministically via the PCIe unit 313 while maintaining determinism in the functional unit(s) 302 of the processor device 301 (e.g., according to methods described above).

In some instances, control unit(s) 304 can include one or more devices for controlling one or more operations of the functional unit(s) 302, such as device(s) configured to supply one or more control signals (e.g., assembly code or machine code instructions; switching signals, multiplexer selection signals, etc.) to one or more functional unit(s) 302.

In some instances, control unit(s) 304 can include one or more instruction control unit(s) 314 configured to supply computer-executable instruction(s) to one or more functional units. In some instances, an instruction control unit 314 can include a deterministic instruction control unit 314 configured to supply instruction(s) to the functional unit(s) 302 according to a predefined program order determined by the compiler; supply instruction(s) at one or more predefined times (e.g., clock cycles, etc.); or the like. In some instances, an instruction control unit 314 can include hardware configured to fetch (e.g., prefetch, etc.) instruction(s) from memory at a first time (e.g., before the instructions are needed; during a time of off-peak memory usage; at a time predetermined by a compiler; etc.) and provide corresponding instruction(s) to one or more functional unit(s) 302 at a second time (e.g., second time predetermined by the compiler, etc.)

In some instances, instruction(s) provided to a functional unit 302 by an instruction control unit 314 can be the same as or different from a corresponding instruction received by the instruction control unit 314. For example, in some instances, an instruction control unit 314 can include a unit configured to translate one or more compiled instructions (e.g., instructions in a first computing language or format output by a compiler, etc.) to one or more control signals (e.g., instructions in a second language or format; other control signals such as multiplexer selection signals or the like). In some instances, translating compiled instructions can include translating a memory-efficient stored instruction to a plurality of control signals that may include a greater data volume than the memory-efficient stored instruction. For example, in some instances, translating compiled instructions can include retrieving, from a memory functional unit 307, a compiled instruction; and providing, based on the compiled instruction, a plurality of control signals to one or more (e.g., a plurality of) functional units 302 over one or more (e.g., a plurality of) clock cycles. In some instances, a memory-efficient stored instruction can include a multi-operation instruction associated with a plurality of related operations (e.g., operations of a machine-learned model layer such as matrix multiplication, activation functions, convolution, attention, or the like), and the translated control signals can include a plurality of control signals (e.g., lower-level instructions, etc.) for executing the multi-operation instruction. In some instances, an instruction control unit 314 can include hardware configured to receive an instruction comprising one or more timing parameters (e.g., delay amounts, etc.) or repetition parameters, and output control signal(s) to the functional unit(s) 302 to cause the functional units to perform operations according to the timing or repetition parameters (e.g., at a predetermined clock cycle defined by a compiler, etc.). In some instances, the instruction control unit 314 can control a timing or a number of repetitions of the functional unit(s) 302 by sending control signals comprising timing or repetition data, or by sending raw control signals at a specific time or plurality of times configured to cause the functional unit(s) 302 to perform operations according to one or more timing or repetition parameters.

In some instances, timing and synchronization units 305 can include various components configured to perform synchronization operations, such as operations to track or communicate time data (e.g., current clock cycle data, etc.) to one or more functional units 302 or other components of a processor device 301. In some instances, timing and synchronization units 305 can include one or more of: one or more hardware-aligned counters 315, one or more software-aligned counters 316, or other timing or synchronization component.

Hardware aligned counters 315 may be used to establish a time base for electronic circuitry in each system, such as a clock, for example. Additionally, each system may include software aligned counters 316. Software aligned counters 316 may be synchronized, for example, based on one or more computer-executable instructions (e.g., compiled instructions determined by a compiler, etc.). Hardware aligned counters 315 and software aligned counters 316 may be implemented as digital counter circuits, for example, on each integrated circuit (e.g., each processor device 301 or each die thereof, etc.). For instance, hardware aligned counters 315 may be free-running digital counters (e.g., 4-bit counters) on a processor device 301 that are synchronized periodically. Similarly, software aligned counters 316 may be digital counters (e.g., 4-bit counters) that are synchronized based on timing markers triggered by one or more compiled programs.

In some instances, timing and synchronization units 305 can include one or more components 305 for internal synchronization of a plurality of components (e.g., functional units 302, etc.) of a processor device 301; one or more components 305 for external synchronization between a first processor device 301 and one or more other devices (e.g., a plurality of second processor devices 301, etc.); or both.

In some instances, synchronizing a first device (e.g., first processor device 301 or another device) with a second device (e.g., second processor device 301 or another device, etc.) can include, for example, synchronizing one or more hardware aligned counters 315 of the first processor device 301 with one or more hardware aligned counters of the second device. Synchronizing the hardware aligned counters 315 may occur periodically during the operation of each system and may occur at a higher frequency than synchronizing software counters 316, for example. Synchronizing hardware-aligned counters may include the first device sending a timing reference (e.g., timing bits representing a time stamp) to the second device over a communication channel (e.g., via chip-to-chip communication units 312, etc.). In some instances, a first system may send an 8-bit time stamp, for example. In such a scenario, a hardware-aligned counter 315 and software-aligned counter 316 of the first device may be maintained in sync locally. However, as the hardware-aligned counter 315 on a first device is synchronized to the hardware-aligned counter 315 on a second device, the software counter 316 on the second device may drift.

In some instances, software aligned counters 316 of a pair of devices can be synchronized by providing, in each of the devices (e.g., as part of a compiled program executed by the devices, etc.), one or more timing markers configured to be sequentially triggered (e.g., at predetermined positions in a compiled program corresponding to particular points of time or particular cycles). In some instances, timing markers in each device may be configured to trigger on the same cycle in each system. For example, a first program on a first device may trigger a timing marker on the same cycle as a second program on a second device when the devices’ hardware aligned counters 315 are synchronized. In some instances, these timing markers may be used to synchronize software counters 316 of both devices. For example, in some instances, timing differences between the timing markers may correspond to a time difference indicative of a degree to which the two devices are out of synchronization, and synchronization can include adjusting a timing of one or more operations based on the time difference. For example, in some instances, a software aligned counter 316 can perform one or more delay operations at each of a plurality of timing markers, and a length of the delay can be adjusted based at least in part on a time difference between the first and second device at the timing marker. However, same-cycle timing is not required; for example, in some instances, a pair of timing markers may be offset by a known number of cycles, which may be compensated for during the synchronization process (e.g., by using different fixed delays, etc.).

In some instances, a timing difference (e.g., number of cycles, etc.) between timing markers may be constrained within a range. For example, a minimum time difference between timing markers in a first and second device may be based on a time to communicate information between the devices (e.g., a number of cycles greater than a message latency), and a maximum time difference between timing markers in the devices may be based on a tolerance of oscillators forming the time base on each system (e.g., if the time difference increases beyond a threshold for a given time base tolerance, it may become more difficult for the systems to synchronize for a given fixed delay). The minimum and maximum number of cycles may also be based on the size of a buffer (e.g., a first in first out (FIFO) memory) in each chip-to-chip communication circuit, for example.

In some instances, synchronizing hardware aligned counters 315 of a pair of devices can include sending, by a first device at a first time t0, a timing reference; and receiving, at a second time t1 by a second device, the timing reference. In some instances, the latency of such a transmission may be characterized and designed to be a known time delay Δt=t_1-t_0. In such instances, synchronizing the pair of devices can include setting, by the second device, a hardware aligned counter 315 to a value of (t0 + Δt) such that the hardware aligned counters 315 of both devices are synchronized.

In some instances, although the first and second devices can be architecturally similar (e.g., same) or different, synchronizing the devices can include, for example, assigning a first device as a designated sender device to send timing data, and designating a second device as a designated receiver device to receive timing data and adjust a timing of the receiver device’s operations based on the timing data.

In some instances, software aligned counters 316 can be synchronized in a manner similar to synchronization of hardware aligned counters 315. For example, in some instances, a software aligned counter 316 can include or implement one or more timing triggers comprising one or more delays (e.g., no-operation (NOP) delays, etc.), wherein a plurality of devices are configured to perform a synchronized delay, such that one or more operations performed after the synchronized delay may be synchronized. For example, in some instances, a first device may send timing data to a second device at t0; and perform a predefined delay operation until t1. A second device may receive the timing data at (t0 + Δt); and determine, based on the timing data, an amount of delay (e.g., number of clock cycles, etc.) to cause the second device to resume operations at t1.

In some instances, synchronization can include fine synchronization (e.g., as described above), coarse synchronization, or both. For example, during various points in operation, the first and second systems may be far out of sync. For example, during startup or after a restart (collectively, a “reset”), a set (e.g., pair, etc.) of devices may perform a coarse synchronization (e.g., using a 20-bit digital counter, etc.) to bring the time bases close enough so they can be maintained in alignment using the techniques described above (e.g., within a resolution of the hardware and software counters, such as 4 bits).

In some instances, synchronizing a number of devices greater than two can include performing similar operations with more than two devices, such as pairwise synchronizations at staggered times, such as pairwise synchronization of a processor device 301 with each of a plurality of neighbors in a chip-to-chip communication topology at a plurality of respective times; one-to-many (e.g., one-to-all, etc.) broadcasting of timing data; pairwise propagation of timing data between pairs of devices according to a propagation pattern or communication topology; or other mechanism for sending and receiving timing data and updating a timing of operations based on the timing data.

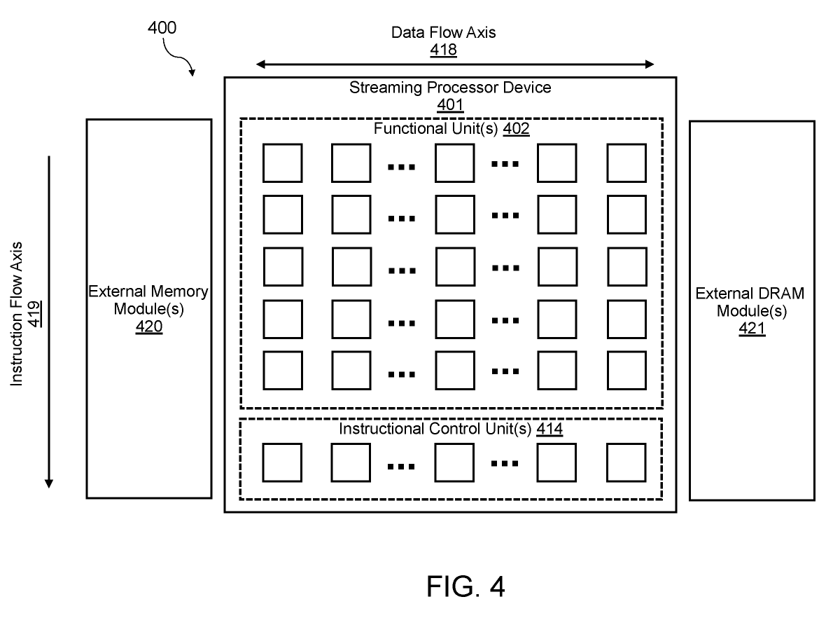

FIG. 4 is a block diagram of an example processor device 401 comprising a plurality of functional units 402 and a plurality of instruction control units 414. In some instances, processor device 401 can be configured to transmit (e.g., stream, propagate, etc.) operand data along a data flow axis 418 and transmit instruction data along an instruction flow axis 419. In some instances, the processor device 401 can be configured to perform one or more deterministic data flow operations, such as transmitting (e.g., streaming, etc.) operand data and instruction data at one or more predetermined times defined by a compiler, such that a compiler can control a timing of operand and instruction data flow to cause an instruction and corresponding operand(s) to intersect at a functional unit 402 for executing the instruction at a predetermined time (e.g., clock cycle) selected by the compiler. In some instances, a processor device 401 can be configured to access one or more external memory modules 420 (e.g., near-compute external memory modules 420, etc.), such as one or more external dynamic random access memory (DRAM) modules 421.

In some instances, a processor device 401 can be, comprise, be comprised by, or otherwise share one or more properties with a processor device 301. For example, in some instances, a processor device 401 can have any property described herein with respect to a processor device 301, and vice versa.

In some instances, a functional unit 402 can be, comprise, be comprised by, or otherwise share one or more properties with a functional unit 302. For example, in some instances, a functional unit 402 can have any property described herein with respect to a functional unit 302, and vice versa.

In some instances, a data flow axis 418 can include a direction, axis, or path along which operand data can flow. For example, in some instances, one or more functional units 402 can be configured to receive one or more input operands along the data flow axis; process the input operands to generate one or more output values; and transmit the output values along the data flow axis 418 to another functional unit 402, which can use the output values as input operands, and so on. In some instances, functional units 402 configured to perform related operations (e.g., pairs of operations associated with some machine-learned inference pipelines, etc.) can be located close together along the data flow axis 418; ordered along the data flow axis in an ordering corresponding to an ordering of one or more sets of related operations; or otherwise geographically arranged on a processor die to reduce a cost (e.g., latency, power cost, etc.) or increase a performance (e.g., throughput, etc.) of one or more operations (e.g., machine-learned inference operations, etc.). For example, in some instances, a series of related operations for machine-learned inference can include one or more of: matrix multiplication (e.g., multiplying machine-learned model parameters by input activations, etc.), activation function operations, mixing or combining operations (e.g., attention-based mixing, etc.), preprocessing or postprocessing operations, or other operations. In some instances, an ordering of such operations can include an ordering associated with one or more of: a transformer layer; a fully connected layer; an attention head; a convolutional layer; a pooling layer; a recurrent layer; a gating layer; or other machine learning architecture component. In some instances, a data flow axis 418 can include a physical axis or a logical axis, such as an operand flow path that may include or not include a straight-line operand flow path. In some instances, all or part of a data flow axis 418 can be orthogonal (e.g., logically orthogonal, physically orthogonal, etc.) to an instruction flow axis 419.

In some instances, an instruction flow axis 419 can include a direction, axis, or path along which instruction data can flow. For example, in some instances, an instruction control unit 414 can be configured to provide, to one or more first functional units 402, an instruction; and the first functional unit(s) 402 can be configured to execute the instruction and/or pass the instruction along to neighboring functional units 402 along the instruction flow axis 419. In some instances, a plurality of neighboring functional units along the instruction flow axis 419 can include a plurality of functional units 402 performing similar (e.g., same) functions, such as a plurality of memory functional units or the like. In some instances, a plurality of neighboring functional units along the instruction flow axis 419 can include a plurality of functional units 402 configured to execute the same instruction received from an instruction control unit 414 and propagated along the instruction flow axis. In some instances, an instruction flow axis 419 can include a physical axis or a logical axis, such as an operand flow path that may include or not include a straight-line operand flow path. In some instances, all or part of an instruction flow axis 419 can be orthogonal (e.g., logically orthogonal, physically orthogonal, etc.) to a data flow axis 418.

In some instances, a processor device 401 can include a deterministic processor device 401 comprising a plurality of deterministic functional units 402 configured to perform one or more operations at a predetermined time defined by a compiler at compile time. In some instances, a compiler can control a timing of one or more instruction and data flows to cause one or more instructions traversing the instruction flow axis 419 to intersect one or more operands traversing the data flow axis 418 at a functional unit 402 scheduled to execute the instruction(s) on the operand(s) at a predefined time instant selected by the compiler.

In some instances, a processor device 401 can include a plurality of functional units 402, which can include functional units 402 arranged in a tiled arrangement on a processor die. The functional units 402 can perform various functions such as vector-matrix multiplication, switching of data along different circuit pathways, and local data storage and retrieval. In some instances, functional units 402 can share a common system clock. In some instances, functional units 402 can include one or more sets of interconnected functional units 402 processing the same data, such as interconnected functional units 402 that are adjacent along a data flow axis 418; at a same location along an instruction flow axis 419; or the like. In some instances, a plurality of interconnected functional units 402 processing the same data can be referred to herein as a “lane” or “Superlane.” For example, in some instances, each functional unit 402 in a Superlane can be subdivided into 16 sub-functional units, and a set of functional units processing the same data can be referred to herein as “lanes.” A set of data that is processed by one Superlane is referred to herein as a ‘stream’. In some instances, each lane in a functional unit of a Superlane can be configured to process one byte (e.g., one byte per clock cycle, one byte at a time, etc.).

In some instances, an instruction control unit 414 can be, comprise, be comprised by, or otherwise share one or more properties with an instruction control unit 314. For example, in some instances, an instruction control unit 414 can have any property described herein with respect to an instruction control unit 314, and vice versa.

In some instances, data between two adjacent functional units 402 can flow bidirectionally, or can primarily (e.g., most or all of the time) move in one direction along a lane or Superlane. In some instances, a first Superlane can have a direction of flow along the data flow axis 418 that is the same as or different from a direction of flow of a second Superlane. In some instances, operand data can be transferred along the data flow axis 419 at every clock cycle of a processor device 401. In some instances, when processing of operand data is complete in one Superlane, the data can be either returned to a host computer comprising the processor device 401 or transferred (e.g., by permute/routing functional units 311, etc.) to another Superlane for additional processing.

In some instances, a Superlane can process streams of data in 16 lanes. In some instances, each instruction can be performed on all 16 lanes at once, and then, if required by the instructions being executed, in the next Superlane in a subsequent cycle, and so forth. For example, in some instances, if a processor device 401 contains N (e.g., 20, etc.) adjacent Superlanes, then an instruction can be passed to N adjacent functional units 402 (e.g., over the course of N clock cycles, etc.), and each instruction can execute on all 16*N (e.g., 320) lanes across the N Superlanes. In some instances, a processor device 401 architecture can include an architecture that lacks register files, and a compiler can schedule the streaming data to be available to the functional unit 402 at a predetermined designated time to execute a designated instruction.

An external memory module 420 can include, for example, a memory device that is external to the processor device 401, such as a memory device on a separate die from the processor device 401 or the like. In some instances, an external memory module 420 can have one or more properties that are the same as or different from one or more properties of a memory functional unit 307. For example, in some instances, an external memory module 420 can include any memory type or device type described herein with respect to a memory functional unit 307. As another example, in some instances, an external memory module 420 can use a first type of memory that is different from a second type of memory used in an on-chip memory functional unit 307. For example, in some instances, a memory functional unit 307 can include a low-latency memory type such as SRAM, and an external memory module 420 can use one or more lower-cost or higher-storage-capacity memory types, such as dynamic random access memory (DRAM). Other memory types are possible without deviating from the scope of the present disclosure (e.g., SRAM or other non-volatile unit memory (NVM) such as 3D NOR memory, NAND memory, FLASH memory, phase change memory such as 3D Crosspoint memory, a next-generation ferroelectric memory, or a Nanotube RAM, etc.). For example, in some instances, an external memory module can have any property described herein with respect to an external dynamic random access memory (DRAM) module 421, and vice versa.

In some instances, an external dynamic random access memory (DRAM) module 421 can include one or more dynamic random access memory (DRAM) components, such as double data rate synchronous DRAM (DDR) such as DDR5, low-power double data rate synchronous DRAM (LPDDR), synchronous DRAM (SDRAM), low-random-transaction-rate DRAM having a low random transaction rate relative to one or more other memory device types (e.g., SRAM, etc.), or other DRAM component(s).

In some instances, an external memory module 420, 421 can include a deterministic memory device configured to perform one or more operations at a predetermined time defined by a compiler at compile time; a deterministic memory device having a known or constant latency for one or more operation types (e.g., read latency, write latency, etc.); or the like.

In some instances, an external memory module 420, 421 can include a plurality of memory banks, wherein each bank has a plurality of rows for storing data. Each memory bank can be addressable by a processor device 401 for writing data to selected rows in selected banks and for reading data from selected rows in selected banks, wherein data can be read a predetermined time period before the data is required to arrive at one or more compute element(s) of the processor 401 and data can be written to a memory at a first predetermined time period that does not coincide with a memory refresh scheduled to occur at a second predetermined time.

In some instances, an external memory module 420, 421 can include various features to enable high-bandwidth memory access, high levels of memory concurrency, or the like. For example, in some instances, an external memory module 420, 421 can provide deterministic memory access functions (e.g., deterministic-latency operations, etc.) to enable a compiler to control a timing of a plurality of data read, write, or refresh operations; control a level of memory concurrency for accessing a plurality of operands or other data from an external memory module 420, 421; or other memory control functions. As another example, in some instances, an external memory module 420, 421 can include a plurality of concurrently accessible memory banks (e.g., memory banks configured to be active simultaneously, etc.), thereby increasing a memory bandwidth of the external memory module 420, 421. In some instances, an external memory module 420, 421 can be configured to access a full row of memory (e.g., without reference to a column decoder, etc.) at each read or write operation. In some instances, a compiler can provide explicit control of memory location allocations, data path routing, and the like to increase (e.g., maximize or nearly maximize, increase relative to partial-row memory access, etc.) a level of memory concurrency of external memory module 420, 421 operations.

In some instances, an external memory module 420, 421 can include a deterministic memory module having low-random-transaction-rate (low-RTR) memory (e.g., DRAM banks, etc.), and a processor device 401 can provide one or more deterministic operations to reduce (e.g., eliminate, etc.) a need for or usefulness of high-RTR memory. For example, in some instances, a plurality of simultaneously active low-RTR memory banks can be used to provide memory access having one or more performance properties (e.g., bandwidth, latency, etc.) equivalent to high-RTR memory.

In some instances, an external memory module 420, 421 can have one or more features to reduce a power consumption of the external memory module 420, 421 compared to some alternative implementations. For example, in some instances, an external memory module 420, 421 can be placed in close proximity to a processor device 401 to reduce (e.g., minimize or nearly minimize) an amount of power consumed in reading or writing data to the memory module 420, 421 (e.g., due to lower capacitive loading of short signal traces, etc.). In some instances, placing an external memory module 420, 421 in close proximity to a processor device 401 can include connecting the module 420, 421 to the processor device 401 in various manners, such as by face-to-face coupling (e.g., using wafer stacking technology, etc.) or another connection technique (e.g., passive interposer, active interposer, etc.). In some instances, a low-power external memory module 420, 421 can include a memory component (e.g., DRAM component) having sense amps attached directly to row input/output (e.g., without a logic layer or without data buffer(s), etc.).

In some instances, an external memory module 420, 421 can include one or more logic dies and a plurality of memory banks, such as a logic die coupled to a plurality of DRAM banks by through-silicon via and to a processor device 401 in a face to face configuration, etc. In some instances, a logic die can include row buffers for interfacing the processor device 401 to one or more memory components. The memory component(s) can also have an array core and a row decoder. During a read operation, the row decoder can select a row of array core and the entire row from the selected row can be transferred from the memory component to row buffers on the logic die. In some instances, a memory component or an external memory module 420, 421 can lack column decoders and can read or write an entire row during each R/W cycle. In some instances, a memory plane can include 3D NOR memory.

In some instances, an external memory module 420, 421 can provide a global address space available to a plurality of functional units 402. For example, in some instances, global memory access can be facilitated by one or more permute/routing functional unit(s) 311 of a processor device 401 to allow any processor 401 component at any location on a die to access data residing in any memory bank element of an external memory module 420, 421 or memory functional unit 307.

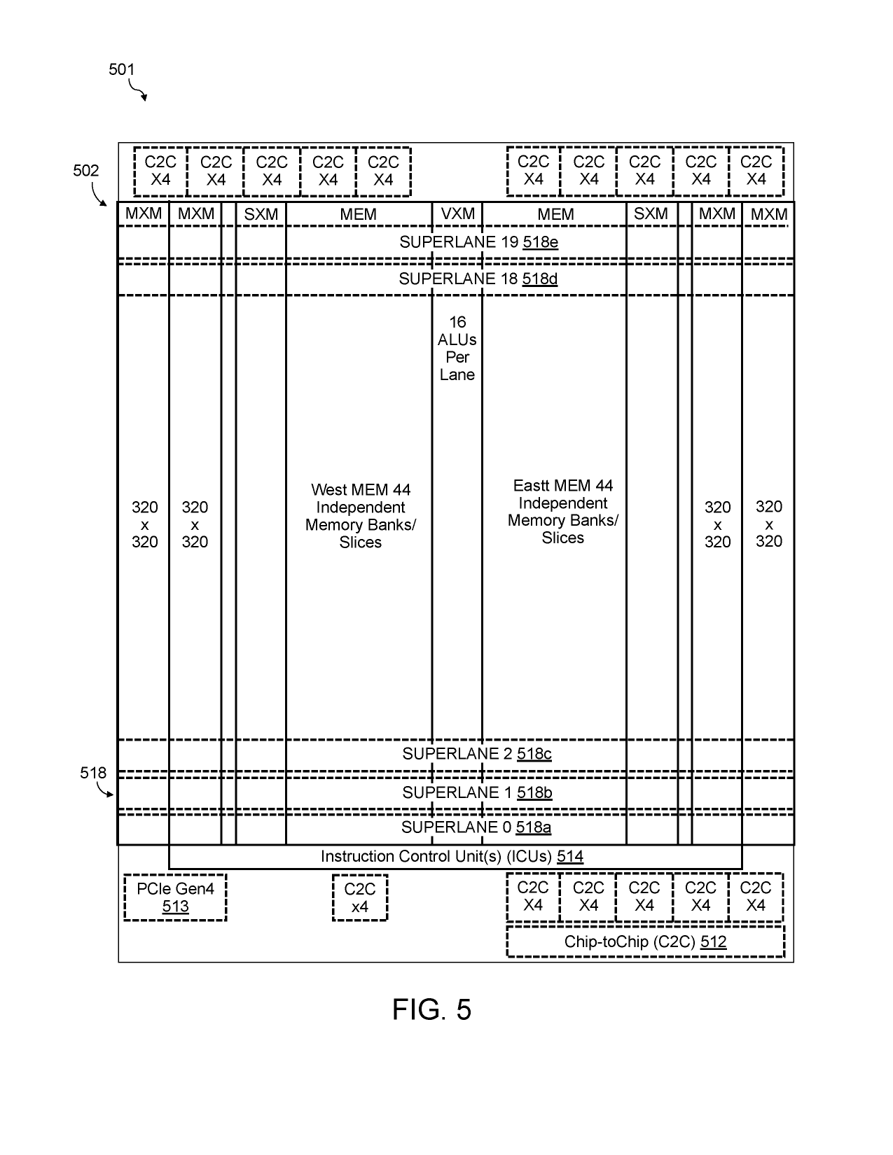

For example, in some instances, a streaming processor device 401 can provide operand data movement along a data flow axis 418 automatically (e.g., at every clock cycle, etc.), while one or more permute/routing functional unit(s) 311 can provide (e.g., responsive to one or more compiled instructions, etc.) operand data movement along an instruction flow axis 419. Further details of an example permute/routing functional unit 311 providing operand data movement along an instruction flow axis 419 are provided below with respect to FIG. 5.

In some instances, a processor device 401 can have sufficient permute/routing functional unit(s) 311 or data flow operations (e.g., routed data flow, automatic or unrouted data flow, etc.) to enable any retrieved data to be mapped to any functional unit 302 or port thereof. In some instances, permute/routing functional unit(s) 311 can provide additional operations in association with memory retrieval, such as data reshaping, padding (e.g., padding a size of a tensor by adding a plurality of zeros, etc.), duplication, or other data routing operations.

In some instances, a processor device 401 and external memory module 420, 421 can operate deterministically (e.g., with deterministic timing, order of operations, etc.), and can have various features to take advantage of such determinism. For example, in some instances, a deterministic processor device 401 can initiate one or more data retrieval operations a predetermined time period before the retrieved data is required to arrive at one or more corresponding compute elements. This can be used, for example, in combination with slow dense memory that may not necessarily provide low-latency or high-RTR performance of individual read operations, as read operations can be scheduled sufficiently far in advance to enable lower-RTR memory device(s) to perform similarly to a high-RTR memory of some alternative implementations. As another example, in some instances, given a processor device 401 that is deterministic, an external memory module 420 can perform non-destructive row reads, as each row can write new data if aligned with a closing row. This can provide for, for example, improved performance, reduced power usage, or both. In some instances, a deterministic processor device 401 can deterministically write new data or deterministically refresh existing data to the row of the DRAM, thereby enabling higher write bandwidth and better management of a refresh function. In some instances, a refresh function can be performed with new data by accessing a DRAM write register loaded with new data. In some instances, the processor device 401 can also treat the external memory module(s) 420, 421 as a circular read/write access medium having an opportunity to read and write every row location. For example, a row address line of an off-chip deterministic near-compute memory unit 420, 421 can be coupled to a clock. The row address line can be configured to receive a row address from the processor device 401 and increment every clock cycle in accordance with the circular medium access until the row address loops back without explicit addressing. This pattern can provide for even further power reduction and performance improvement while implicitly incorporating refresh support.

In some instances, a processor device 401 can use one or more memory functional unit(s) 307 (e.g., SRAM units, etc.) or another buffer device (e.g., external SRAM units interposed between a processor device 401 and external DRAM module 421, etc.) as a buffer to temporarily store data retrieved from the external memory module(s) 420, 421, or the processor device 401 can be configured to provide retrieved data directly to one or more functional unit(s) 402 for processing or routing (e.g., traversal of a data flow axis 418, etc.).

FIG. 5 is a block diagram of an example language processing unit device 501 according to example implementations of aspects of the present disclosure. The language processing unit (LPU) device 501 can include a plurality of functional groups 502, along with a plurality of data paths 518a, b, c, d, e (collectively, data paths 518) between the functional groups 502. In some instances, the functional groups 502 can include one or more vector functional groups 510, one or more memory functional groups 507, one or more permute/routing functional groups 511, and one or more matrix functional groups 509. In some instances, a language processing unit 501 can further include a plurality of communication units 303 (e.g., PCIe unit(s) 513, chip-to-chip communication unit(s) 512, etc.); a plurality of instruction control unit(s) 514; or other component(s).

In some instances, one or more of a processing device 501, functional unit 502, communication unit(s), memory functional unit/group 507, matrix functional unit/group 509, vector functional unit/group 510, permute/routing functional unit/group 511, chip-to-chip link 512, PCIe 513, or instruction control unit 514 can be, comprise, be comprised by, or otherwise share one or more properties with a component having a similar (e.g., same, etc.) name or part number described herein with respect to another Figure, such as FIGS. 3 or 4. For example, in some instances, a processing device 501 can have any property described herein with respect to a processing device 301 or processing device 401, and vice versa; a functional group 502 can have any property described herein with respect to a functional unit 302 or functional unit 402, and vice versa; and so on.

In some instances, a processor device 501 can include one or more functional regions or sets of functional units 502 with the same functionality executing the same instructions, such as functional units 502 located in similar positions in different Superlanes (e.g., at a same point along a data flow axis 418, etc.). In some instances, such a functional region or set of functional units 502 with the same functionality executing the same instructions can be referred to herein as a functional group or “slice”. In some instances, a processor device 501 can include one or more sets of directly connected functional groups of the same functional modules, encompassing all the Superlanes, is referred to herein as a “partition.”

In some instances, a LPU 501 can include a plurality of functional groups, wherein each functional group in a LPU can perform any of a variety of functions under the control of instructions transferred from buffers in the Instruction Control Unit 514. For example, in some instances, functional groups 502 can include memory functional groups 507 for memory storage and retrieval for data in a Superlane (MEM); functional groups 502 (e.g., matrix or vector functional groups 509, 510, etc.) for integer (INT) arithmetic or floating point (FPU) arithmetic; or permute/routing functional groups 511 for transferring data between Superlanes (NET or SXM). In some embodiments, each of the functional groups 502 can operate independently, and operations of different functional groups 502 can be coordinated using barrier-like synchronization instructions.

For example, the memory functional groups 507 can perform Read and Write operations but not Add or Mul, which can in some instances be performed only in matrix functional groups 509 and vector functional groups 510. In some instances, all of a plurality of functional units in a functional group 502 can execute the same set of instructions, so it is possible to locate all of the common instruction decode and dispatch logic into the ICU 514, and partition the normal instruction execution pipeline into two sets of instructions: (i) instruction fetch, decode, and parceling and (ii) operand read, execute, and writeback. Functional groups 502 or components thereof can operate without having to receive explicit instructions, or only receiving intermittent or limited instructions, from the ICU when the functional units are dedicated to a specific function, potentially simplifying operation of the processor.

In some instances, a functional group 502 can include a plurality of functional units 402 (e.g., functional units organized along an instruction flow axis 419, etc.). In some instances, functional units in the same functional group 502 (but not necessarily the same Superlane) can execute instructions in a “staggered” fashion where instructions are issued functional unit-by-functional unit within the functional group over a period of N cycles. For example, the ICU 514 for a given functional group may, during a first clock cycle, issue an instruction to a first functional unit of the functional group (e.g., the functional unit directly connected to the ICU of the functional group), which is passed to subsequent functional units of the functional group along an instruction flow axis 419 over subsequent cycles.

In some instances, a processor device 501 can include a first and second matrix functional group 509 or first and second set of matrix functional groups 509; a first and second permute/routing functional group 511 or first and second set of permute/routing functional groups 511; a first and second memory functional group or first and second set of memory functional groups 507; and a first vector functional group 510. For example, in some instances, each Superlane can include a first set and second set of matrix multiplication functional units (MXM1 and MXM2), a first and second set of data path switching functional units (SXM1 and SXM2), a first and second set of memory functional units (MEM1 and MEM2), and a first set of vector calculation functional units (VXM1), wherein just one functional unit in MXM1 transfers data with one functional unit in SXM1, wherein just one functional unit in SXM1 transfers said data with just one functional unit in MEM1, wherein just one functional unit in MEM1 transfers said data with just one functional unit in VXM1, wherein just one functional unit in VXM1 transfers said data with just one functional unit in MEM2, wherein just one functional unit in MEM2 transfers said data with just one functional unit in SXM2, and wherein just one functional unit in SXM2 transfers said data with just one functional unit in MXM2.

In the above example, data transfers are entirely in one direction, for example MXM1 to SXM1 to MEM1 to VXM1 to MEM2 to SXM2 to MXM2. However, in other examples, data transfers can occur in multiple (e.g., two, etc.) directions, for example, one set of data transfers from VXM1 to MEM1 to SXM1 to MXM1, and another set of data transfers from VXM1 to MEM2 to SXM2 to MXM2.

In some instances, each Superlane, and in some instances the entire LPU 501, can execute a single set of instructions, such that the LPU 501 may be considered as a single processor core. However, in some instances, the LPU 501 Superlanes can be partitioned into two sets of functional modules. For example, in a split architecture with only one central vector functional group 510, a central vector multiplication functional unit that contains 16 ALUs can allocate the ALUs to either set. In other instances, additional vector functional groups 510 may be allocated to a set. The additional vector functional groups 510 may be physically or logically located, for example, next to one of the matrix functional groups 509.

For at least one embodiment, FIG. 5 can depict the silicon layout of a LPU 501 with multiple Superlanes, as well as processor chip to processor chip (C2C) interface modules 512 and the ICUs 514. In this example embodiment, there are 20 Superlanes forming the majority of the floorplan of the laid-out silicon circuitry. Surrounding the Superlane partitions is circuitry for the ICUs, modules for processor-to-processor communication, and modules for host-to-processor communication. In one embodiment, the host-to-processor modules comprise a PCIe (Peripheral Component Interconnect Express) circuit 513. In some instances, a host-to-processor communication module can bidirectionally transfer data from the host computer through a permute/routing functional group 511 to and from a memory functional group 507. In some embodiments, a processor-to-processor communication C2C module 512 directly transfers data to a permute/routing functional group 511.

One example implementation of a LPU 501 chip contains 46.8 billion transistors on a 325 mm2 die built in 34nm ASIC technology, and is designed using standard EDA tools from circuit design through tape-out before fabrication. The die area splits about evenly between memory and compute units (not counting I/O). Instruction control requires only 5% of the die area. One Superlane in the example LPU 501 can be initially unused, so it can be connected to the rest of the architecture to replace any Superlane that is defective; this redundant feature adds only about 4% to the die area. In this embodiment, each memory partition can have 44 memory functional groups 507 each comprising 20 memory functional units 402.

In some instances, a LPU 501 can include a large on-chip Static Random Access Memory (SRAM), which can in some instances reduce or eliminate a need for external memory. For this reason, a LPU 501 may not need to include DRAM controllers and interfaces. However, a processor device 301, 401, 501 can include a processor device configured to interact with external memory (e.g., external DRAM, etc.) without deviating from the scope of the present disclosure. Some example LPU 501 chips can include an x16 PCI Express (PCIe) Gen4 interface to connect to a host processor (e.g., central processing unit of a host computing device, etc.). In some instances, compilers that execute on the host computer or another device can download the machine learning algorithm instructions and data to the LPU 501, typically from the host computer through the PCIe interface 513 through permute/routing functional units 311 (e.g., functional units, etc.) adjacent to the PCIe interface 513 into the memory functional groups 507 (e.g., MEM partitions comprising one or more memory functional groups 507, etc.). The LPU 501 can then autonomously execute the model by transferring the instructions and data in the MEM partitions into one or more functional groups 502. After processing, in some instances, results can be transferred from one or more functional groups 502 (e.g., vector functional group(s) 510, etc.) back to the host computer (e.g., via one or more permute/routing functional groups 511 and via one or more PCIe devices 513).

Machine learning algorithms can in some instances operate on vectors with scalar coefficients of a specified data type (e.g., INT8, FP16, etc.). In some instances, Superlanes of a LPU 501 can operate on data representing vectors, sometimes organized into rank-2 tensors. In some instances, a LPU 501 can operate on higher-rank tensors by using a compiler to transform higher-rank tensors into rank-2 tensors. In some instances, a LPU 501 can implement a programming model that is a producer-consumer model where each functional group in a partition acts as a consumer and a producer of one or more streams.

In some instances, a LPU 501 architecture can support a plurality of streams (e.g., 32 streams, etc.) in each set of functional units in two directions. In some instances, a number of streams can be dependent on the availability of wiring of the inputs and outputs for the stream registers. In some instances, each stream can automatically progress in a designated direction (e.g., designated direction along a data flow axis 418 or data path 518, etc.) on every cycle (e.g., moving 32 bytes each cycle via 32 streams, etc.). In some instances, inter-lane data movement (e.g., data operand movement in a direction other than the data flow axis 418, etc.) within a vector can be performed using a permute/routing functional group 511.

When a set of data representing a vector is read from main memory, it can be given a stream identifier (0..31) and direction of flow in a Superlane. Once a vector is read into one or more stream registers in a lane, it can become a stream and flow towards a functional group 502 that is scheduled to process the vector, and the functional group 502 can process the vector to produce a result stream. As data in a stream flows through a functional group, each functional module can intercept the data and perform a calculation (if the module is calculational), or move data between lanes (e.g., in permute/routing functional group(s) 511).

The stream registers can be used to transfer operands and results between functional groups. An example software pattern can include reading operand data from one or more memory functional groups 507 that is then subsequently consumed and operated on by a downstream arithmetic functional group (e.g., matrix functional group 509, vector functional group 510, etc.). The results of the operation can then be transferred to another stream such that they can be written back to memory. For example, a Z=X+Y operation might be performed by executing four instructions: Read S1,X and Read S2,Y are executed on two memory functional groups 507 and directed toward a vector functional group 510 to perform the Add S1,S2,S3. Then the result can be stored back to a memory functional group 507 via a Write S3,Z.

An instruction can operate on data from different streams. For example, ADD S1, S2, S3 adds each value in stream 3 to the corresponding value in stream 4 and stores the results in stream 5.

In some instances, a functional group 502 can include a functional unit 302 configured to perform a given operation (e.g., operation associated with a single instruction received from an instruction control unit 514, etc.) for a plurality of repetitions on operands streamed over a plurality of clock cycles. For example, in some instances, a functional group 502 or component thereof (e.g., functional unit, etc.) can be configured to receive an instruction comprising repetition data indicative of a number of times to repeat a given operation; a number of clock cycles to delay between repetitions of the given operation; or other repetition data. Based on the instruction, the functional group 502 can perform, at each of a plurality of clock cycles, the given operation on one or more operands arriving in one or more streams (e.g., Superlanes, etc.) at each of the plurality of clock cycles.

A lane structure configured to hold one byte per lane can be well suited for INT8 data, but larger operands (INT16, INT32, FP16, or FP32) can also be formed by combining streams. This approach can provide for a compiler to operate, for example, on 320-element vectors for all data types. Wider data types can be assigned to adjacent streams along aligned boundaries. For increased reliability, a Superlane can apply a 3-bit error-correction code (ECC) across all 16 lanes, correcting nearly all errors. A LPU 501 can log these errors and report them to a host computer. In one embodiment, the ECC protocol is SECDED (single-error correction with double error detection). Before a functional group operates on a stream of data, it can check the ECC bits to ensure data integrity before operating on the data.

In some instances, each element of a stream can be 1-byte, with larger data types (e.g. INT16, INT32, and FP32) constructed from several streams (2, 4, and 4 respectively). Multi-byte data types can be handled such that they are always stream-aligned based on the size of the data type. For instance, INT16 can be aligned on a stream pair, bi-stream, and INT32 can be aligned on a quad-stream (e.g., one set of four adjacent data paths 518 per INT32 value, etc.). Data alignment can be accomplished by the compiler or through an application programming interface (API).

In some instances, each stream can have one or more “valid/empty” bits precisely tracking the stream’s load-to-use time beyond which the stream is considered logically dead and no longer propagated, which can achieve a reduction in power consumption of the LPU 501.

Some instructions in the ICUs 514 can be common to all functional groups 502. As such, the instructions can contain common instructions like NOP and Repeat, and synchronization instructions Sync and Notify to allow the functional groups 502 to be initially synchronized, so a compiler can accurately determine instruction execution times and allow cooperative parallelism among the functional groups. ICUs 514 can retrieve pages of instructions in the MEM partitions, sending Ifetch instructions across side channels in the memory functional groups, and receiving the instructions from memory back along the same side channel.

The ICUs 514 can provide explicit instruction fetching for the functional groups with the Ifetch instruction, and inter-functional group synchronization using the Sync and Notify instructions to perform a chip-wide barrier synchronization among participating functional groups. A repeated-NOP instruction can allow for precise cycle-by-cycle control of inter-instruction delay. For example, a compiler can have cycle-accurate control when scheduling two operations A and B using an intervening NOP so that N clock cycles separate the operations A and B, i.e., Operation A then NOP(N) then Operation B.

A compiler can use explicit NOPs to provide temporal separation between two instructions in the program order. A NOP can have a repeat count 16-bit field which allows one NOP to wait between 1 ns and 65 μs for a 1 GHz clock frequency. A compiler can use NOP instructions to control relative timing of the functional groups 502 and data on which the functional groups operate. A repeated NOP can be implemented in the ICU 514 and can be common to all functional groups 502. While a NOP instruction can be the most common instruction, the NOP instruction may not be included in the specification for a machine learning model, but rather may be inserted into the instructions generated from the model by a compiler.

In some instances, a vector functional group 510 can include a central vector functional group 510 containing 16 Arithmetic Logic Units (ALU) per lane. Each ALU can perform, for example, a 32-bit calculation using aligned groups of four stream bytes as operands. In addition to the usual arithmetic and logical operations of some conventional ALUs, ALUs of a vector functional group 510 can be configured to convert between integer and floating-point formats. In some instances, a vector functional group 510 can be configured to perform some predefined normalization functions such as ReLU and the hyperbolic tangent (tanh) as well as exponentiation and reciprocal square roots, allowing programmers to build their own normalization functions.

In some instances, a language processing unit device 501 can be organized into a plurality of Superlanes, and a vector functional group 510 can implement, for each Superlane, a 4x4 mesh of vector ALUs using the 16 vector ALUs per lane. In some instances, an ALU can be configured to receive 32-bit input operands, wherein each of an ALU’s 32-bit input operands are organized along an aligned quad-stream group.

In some instances, a vector functional group 510 ALUs can include stateless ALUs, such as ALUs that do not produce condition codes or status flags from the last instruction. For example, in some instances, instead of condition codes or status flags, a vector functional group 510 can provide both saturating and modulo variants (add_sat, add_mod and mul_sat, mul_mod) for addition and multiplication, which can allow differing semantics for handling arithmetic exceptions. In some instances, a language processing unit 501 can support chaining together two or more vector ALUs within each lane, allowing multiple ALU operations to be performed without transferring the intermediate results to main memory, saving a write and subsequent read of each intermediate result. This can in some instances allow for efficient parallel implementations of algorithms for batch normalization, quantization, or more complex activation functions like the leaky ReLU activation function, for example.

In some instances, a matrix functional group 509 partition can include a plurality of independent regions (e.g., grids, etc.) of multiply-accumulate modules, such as four independent 320-by-320 grids of multiply-accumulate (MACC) modules. In some instances, each 320 by 320 grid can include 20 16 by 16 sub-grids that each produce a partial-sum / dot product result each cycle and pass the result to an adjacent functional unit 402 for use in its computations. In some instances, an N by N grid can use N streams each with N bytes to install N2 parameters (e.g., 4-bit weights (IW), etc.) in each grid on every cycle. Using all 32 streams in each direction can allow weights to be placed simultaneously in multiple matrix functional group 509 partitions, loading 409,600 weights (e.g., all weights of some example machine-learned models or model partitions, etc.) on-chip in less than 40 cycles. With weights installed, every cycle the matrix functional group(s) can generate a new dot-product (e.g., INT32 dot product, etc.) of input activations with installed weights. The features output from the matrix functional group(s) 509 can be accumulated using accumulators on each INT32 or FP32 output stream.

In some instances, a matrix functional group 509 can support calculations for multiple numerical formats by combining results from multiple lanes. For example, in some instances, a matrix functional group 509 can support both 4-bit integer (INT8), and 16-bit floating point (FP16), by using two 320 x 320 byte-planes in tandem for the 16-bit floating point results. In some instances, a 320-element sum can be produced for each output with only a single rounding step at the end to convert to INT32 or FP32 results. Matrix functional group 509 processing can include, for example, one or more of the following operations (instructions): LW – load weights from data flows (streams) to weight buffer; IW – install weights from data flows (streams) or LW buffer into the 320x320 array; ABC – activation buffer control to initiate and coordinate arriving activations; ACC – accumulate either INT32 or FP32 result from MXM.

In some instances, each MACC unit can have two 4-bit weight registers and two 32-bit accumulators. On each cycle, each MACC unit can multiply the stored weight values by a pair of activation values from the streaming data. In some instances, each 16x16 sub-grid can compute an integer partial sum in one cycle and a complete 320-element fused dot-product in 20 cycles. In some instances, a MACC unit can instead operate as a single FP16 MACC, but these operations can require two cycles, reducing throughput by 35% relative to INT8 operations. In some instances, each matrix functional group 509 partition can have 320x320 MACC units producing 409,600 INT8 operations or 102,400 FP16 operations per cycle. Using all 32 streams in each direction, the LPU can load all 409,600 weight registers in less than 40 cycles.

The permute/routing functional group(s) 511 (sometimes referred to herein as switch units, ‘SXM’ or ‘NET’) can execute functions for the transposition, permutation, shifting and rotation of data elements. Collectively, these operations can be used for performing tensor reshape operations, such as tensor reshape operations associated with one or more machine learning operations. For example, in some instances, a permute/routing functional group 511 can rotate or transpose a stream of data across the lanes. In some instances, a permute/routing functional group 511 can duplicate bytes to fill a vector or zero any of the vector elements to pad values. In some instances, permute/routing functional group 511 can be the only functional units of a processor device 501 that communicate between Superlanes. Further details of some example permute/routing functional groups 511 are disclosed in U.S. Patent 10,754,621, incorporated herein by reference.

Data movement on-chip can be carried out by routing data along one or more pathways, such as pathway(s) where data is transferred between SRAM and functional modules within each Superlane, and pathway(s) where the permute/routing functional group 511 transfers data across lanes using two sets of lane shifters. The lane-shifters can in some instances be allocated in pairs to facilitate shifting a vector between a lane and its two adjacent lanes in a Superlane. Additionally, in some instances, the permute/routing functional group 511 can provide a permute instruction that uses a programmed bijection to remap a plurality of lanes (e.g., 320 lanes, etc.) onto a set of similarly indexed streams, one per Superlane.

In some instances, permute/routing functional group 511 can include one or more distributor functional groups. For example, a distributor functional group within a permute/routing functional group 511 can be used to arbitrarily remap a plurality of (e.g., 16) lanes within each Superlane. As streams pass through the SXM’s distributor, they can be remapped at full bandwidth, or zero-fill any or all of the 16 elements. This can provide an efficient mechanism for common tensor operations like zero padding or rearranging elements of a convolutional neural network filter (e.g., 4x4 filter, etc.).

An example operation on tensor data types can include transposition. In some instances, a LPU 501 can support a two-dimensional transpose of 456 elements organized as 16 streams each with 16 elements. A transpose operation can take 16 incoming streams and produce 16 output streams with the rows and columns exchanged. This allows the efficient movement of data from the atomic 16-byte MEM word into 16 different MEM functional groups where they are now addressable. In some instances, a LPU 501 can include two instances of the SXM on-chip, one in each hemisphere. Each can issue, for example, two (2) transpose instructions, yielding a maximum of four (4) simultaneous transpose 16x16 operations.

In some instances, a tensor streaming processing device 501 can have a plurality of memory partitions (e.g., two partitions, etc.) each having 44 memory functional groups 507 comprising ECC-protected SRAM, with each functional group comprising 20 functional units that provide a total capacity of 4.5 MiBytes (wherein a MiByte is 1048576 bytes) per functional group, giving the two MEM partitions a total capacity of 420 MiBytes. Each memory functional group 507 can include, for example, at least two sets of memory cells referred to as ‘banks’. Each MEM functional group can include pseudo-dual-port SRAMs that can service a pair of read and write requests simultaneously, assuming they are not targeting the same bank. In such instances, the 44 memory functional groups 507, each with 4 banks, can enable up to 176-way memory concurrency to read operands to or store results from streams. Banks of memory not being used can have their power reduced to reduce energy usage.

In some instances, the memory functional groups 507 can be configured to provide sufficient memory concurrency to supply a target number (e.g., 32, etc.) of operands per lane, every cycle. For example, in some instances 44 functional groups having 176-way memory concurrency can provide sufficient concurrency to supply 32 operands per lane each cycle. In some instances, memory functional groups 507 can be partitioned into 16-word bytes, each word distributed across a Superlane, and each byte of each word processed by one lane of the Superlane. In some instances, a memory functional group 507 can perform two 16-byte reads and two 16-byte writes per cycle, as long as they access different banks, allowing it to both source and sink data in two directions across all lanes in a Superlane.

In some instances, on-chip memory can supply operands for each functional group 502 by reading an address from a memory (MEM) functional group 507, denoted MEMi. In some embodiments, functional groups in each memory can be numbered 0 to 43, with MEM0 closest to the vector functional group 510 and MEM43 nearest to the permute/routing functional group 511.

In some instances, memory partitions can enable the programming abstraction of a partitioned global shared address space with the address space laid out uniformly across the functional groups. In some instances, each memory functional group 507 can support both direct and stream-indirect addressing modes. Read and Write operations can use direct addressing, since the address is fully specified in the instruction itself. Indirect addressing can use the contents of a stream, s, to specify an address map for a Gather or Scatter. With indirect addressing, the physical address can be transmitted within the stream value, providing a layer of indirection in the memory referencing.

This iteration mechanism in the address generation circuitry can support, for example, multiple levels (e.g., up to four-levels, etc.) of nested iteration allowing for multi-dimensional arrays to efficiently encode tensors as a short sequence of read or write, or gather or scatter, operations followed by countdown, step, and iter instructions to control the loop bounds. The countdown instruction can specify an inter-loop delay in cycles.

As a non-limiting illustrative example, consider a LPU 501 having a 1 GHz operating frequency of the LPU 501 clock. The stream register bandwidth, B, exported by each MEM interface on the East and West edge of each MEM partition can keep the functional modules adequately fed with data operands in order to saturate the peak arithmetic capacity of the functional modules. The stream registers can provide a combined capacity of 20 TiB/s of read (operand) and write (result) bandwidth.

To maximize stream concurrency, a compiler can allocate memory for concurrent stream operands associated with a single tensor into separate memory functional groups 507. For example, as the streams propagate through the MEM system they can “pick up” the arguments from a plurality of separate memory functional groups 507 enroute to one or more other functional groups 502 (e.g., matrix functional groups 509, etc.). In some instances, a compiler can explicitly schedule individual banks of each MEM functional group to achieve fine-grain memory management. This can enable design patterns and use-cases where simultaneous reading of operands from one bank and writing of results to the other bank in the same memory functional group 507. As an example, a transpose instruction can take 16 input streams and produce 16 output streams with the rows and columns transposed. By using the bank concurrency available within each memory functional group 507, it is possible to use the pseudodual-ported SRAM for dual read/write accesses per memory functional group 507.

In some instances, a LPU 501 can include a memory system that is unlike a memory system of a conventional central processing unit (CPU). For example, some conventional CPUs may rely on a memory hierarchy to implicitly move data between caches to service load/store operations. Cache hierarchies can introduce a reactive agent in the data path and can introduce undesired unpredictability, or non-determinism, in the data path to provide the illusion of sequentially consistent memory transactions within the memory hierarchy.

In some instances, the memory functional groups 507 can store very long instruction word (VLIW)-like instructions, such as instructions that are 2,304 (144x16) bytes wide. In some instances, a program can fetch instructions when the memory functional groups 507 are otherwise idle. For example, in some implementations, instruction fetches can require less than 10% of the total memory bandwidth of the memory functional groups 507. Instructions can be decoded and loaded into queues, allowing the program to prefetch. To reduce code size, a REPEAT N instruction can repeat a previous instruction N times. In some instances, a program can specify a NOP instruction to last for N cycles.

Each functional group 502 can have a predefined set of instructions (e.g., Read, Write, Add, Mul, etc.) that define its supported operations. Furthermore, functional groups 502 can consume operands from, and produce results to, streams. A more complex sequence of operations, a microprogram, can be composed of one or more functional groups 502 coordinating in a producer-consumer manner to create one or more output streams. This can be accomplished by logically chaining multiple functional groups 502 together to consume input data from up-stream functional groups 502, operate on that data to produce a new result stream, where it later can be consumed by a downstream functional group 502 in a similar manner. In some instances, each functional group 502 can choose a direction of its result stream. With this cooperative producer-consumer model operating on data streams, more elaborate operations can chain together different functional groups 502, for example, where a composite function, F (x, y, z) = MEM(x) → SXM(y) → MXM(z), is an amalgam of several functional groups 502 chained together.

This dataflow composition exploits ‘data flow locality’ by passing the same data across multiple functional groups 502 which can operate on the data to produce some output stream. The output from one functional group 502 can be transferred to the input of another functional group 502 allowing for chaining of operations through a common stream register.

In some instances, the underlying data type supported by a LPU 501 can be a vector. For example, in some instances, number of elements in each vector can vary from 16 elements, one Superlane, all the way to 320 elements using all 20 Superlanes on-chip. That is, the minimum vector length, or minVL, can be 16 bytes and the maximum vector length, or maxVL can be a 320 byte-sized element array. Because the vector length can vary from 16 to 320 elements, instructions can configure each functional unit for a low-power mode to effectively power down any unused Superlane (row of the mesh) and reduce the power consumed. This scalable vector approach allows the vector length to grow from 16 to 320 bytes in 16-lane steps, powering-down the unused functional units, yielding a more energy-proportional system.

In some instances, an instruction set architecture of a LPU 501 can provide temporal information about each instruction to allow a compiler precise control of each instruction’s dispatch time. For example, in some instances, each instruction can be augmented with one or more of the following temporal parameters:
dfunc functional delay -- each instruction requires 1 or more cycles to produce its stream output. A functional delay timing parameter can allow the compiler to reason about when the output of an instruction will be available on the architecturally-visible stream registers.
dskew instruction-operand skew -- the timing relationship between the instruction dispatch time relative to when its stream operands are required. An instruction-operand skew parameter on each instruction can inform a compiler how to schedule the operand arrival times with the instruction dispatch time in order to get them to properly intersect in time and space.

Such parameters can be useful to track the exact spatial relationship between instructions and operands.

In some instances, a programming model for a LPU 501 can include, for example, the following two elements: (1) scheduling specific data paths in hardware, and (2) exposing temporal information about an instruction’s execution latency through the Instruction Set Architecture (ISA), so that the compiler’s back-end can precisely track the position and time-of-use of any stream on-chip.

A compiler can use NOP instructions to control the relative timing of the functional groups 502 and the data on which they operate. A NOP can have, for example, a repeat count 16-bit field which allows one NOP to wait from 1ns up to 65μs for a 1GHz clock. The NOP instruction can be implemented in the ICU’s functional unit and can be common to all functional groups. The NOP can allow the functional group to turn off the clock when performing no operations for anything longer than a few cycles (i.e., n >4 cycles).

Each functional group 502 can be independent; however, the compiler can keep track of a logical program time. Conceptually this can be similar to a program counter in a conventional CPU, except the compiler can track the state of a plurality of (e.g., 144, etc.) independent program queues on a cycle-by-cycle basis. So, at logical time t the compiler can know the state of each Instruction Queue (IQ) inside each Instruction Control Unit. NOP instructions coordinate the temporal relationship between instructions in the same IQ, or between instructions in different IQs. In addition to repeated-NOPs, a higher-level synchronization across all functional groups 502 on a chip can be enabled in order to reason about program correctness. For example, in some instances, Sync and Notify instructions can provide a barrier synchronization mechanism across all independent queues on the LPU 501. One IQ can be designated as a notifier configured to issue a Notify instruction while all other IQs can be parked on a Sync instruction. The receipt of a Notify can be broadcast to all the IQs to satisfy the pending Sync and begin processing instructions again.

This barrier synchronization can be performed, for example, only once after the LPU 501 resets. However, in practice, some programs may start with a set of “preamble” instructions which configure each functional unit. After that a Sync instruction can be performed to ensure that all functional groups are aligned to the same logical time. In some example embodiments, a chip-wide barrier synchronization can be accomplished in 55 clock cycles, from the time a Notify is issued to the time a Sync is satisfied and retired to allow subsequent instructions to flow. After this barrier synchronization, the functional groups 502 can compute and communicate results in a synchronization-free manner through the stream registers.

Repeat (n, d) is an ICU instruction issued to repeat a previous instruction n times, with d cycles between each iteration. Allowing variable amounts of delay between iterations can allow a compiler to temporally align the repeated instruction with its operands in-flight. This simple but flexible iteration mechanism can allow vector functional groups 510 and matrix functional groups 509, which are often highly iterative, to encode their instructions more efficiently by making better use of main memory and reducing the number of Ifetch instructions compared to if the loop were unrolled.

An Ifetch instruction can have a single stream operand which carries the instructions in their program order, filling an instruction queue with, for example, 640-bytes (e.g., a pair of 320-byte vectors) of instructions. In some instances, all functional groups 502 can fetch instructions simultaneously with normal instruction execution. In some instances, a compiler can perform omniscient prefetching of the program’s instructions to keep all 144 IQs busy on each cycle by inserting Ifetch instructions into every functional group’s instruction stream. In some instances, a LPU 501 or compiler can include a mechanism to ensure that IQs never are empty so that a precise notion of ‘logical time’ is maintained across the processor.

In some instances, a LPU 501 can be configured to transmit data along a stream without packet routing, arbitration, or the like. For example, on each tick of the core clock, the LPU 501 can propagate stream values by one stream register hop. The LPU 501 hardware can, for example, propagate stream values without tracking the origin or destination functional group, such as by allowing streams to simply propagate until they fall off the edge of the chip or are overwritten by a functional group 502. In some instances, a LPU 501 can use stream registers within each memory functional group 507 to move data along a Superlane, and can use one or more permute/routing functional groups 511 to move data between Superlanes. An instruction can specify one or more source streams-direction pairs, and a target stream and output direction for the result, effectively providing direction routing of the stream data.

In some instances, a network of LPU 501 processors can be connected via Chip-to-Chip (C2C) modules 512. The processors 501 can logically behave as if all chips share a common clock and are connected via time multiplexed wires. LPU 501 chips connected via C2C 512 do not need to share a clock; reasonable alignment of the frequency of the clocks (measured in PPM) can suffice. In some instances, receive buffers in the communications modules can be large enough so that the expected PPMs of clocks don’t require a realignment more than once per millisecond, or otherwise don’t require realignment often enough to cause difficulty in scheduling between model executions.

In some instances, C2C modules 512 can either provide sufficient Forward Error Correction for data transfer between chips such that unrecoverable errors will occur <1 per week per chip when using all C2C links, or provide software with a mechanism to add additional redundancy so that errors will occur <1 per week per chip when using all C2C links 512. If error rates are lower at a lower transfer rate (e.g. 16Gb/s), then SerDes can be configured to run at a lower rate for improved precision.

Transfers of data between LPU chips 501 during a compute phase of a program can be supported, e.g. while COMPUTE[i].CHIP[A] is running on chip A, it may send data to COMPUTE[i].CHIP[B] on chip B, which may result in data being returned to COMPUTE[i].CHIP[B] and used before the computation completes. This can differ, for example, from some PCIe 513 implementations, which may only allow data to be transferred before and after a COMPUTE phase.

In some instances, each C2C 512 SerDes of a LPU 501 can be an independent link, e.g., each link may be the only connection to another device or may be one of multiple connections to another device. Multi-chip systems can be implemented in a variety of topologies for flexible packaging and deployment in rack-scale and cluster scale systems. Communication can occur in a pair-wise manner between a sender port and a receiver port. A sender can perform a MEM read to read an address a onto a stream heading toward a permute/routing functional group 511. The permute/routing functional group 511 can perform a Send on the C2C unit 512 representing the physical port where the data is transmitted. On the other side of the link, after a fixed delay for time-of-flight on the wire, the LPU 501 performing the Receive instruction can pull, for example, a 320-byte vector off the channel for every Receive issued.

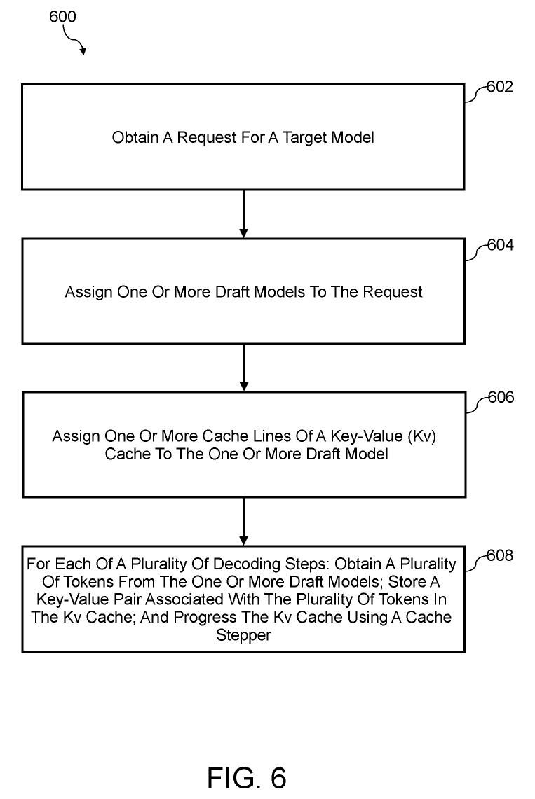

FIG. 6 depicts an example method 600 according to some implementations of example aspects of the present disclosure. The method 600 can include, at 602, obtaining a request for a target model. This request is generally received from a user via a user device and specifies a generative task, such as providing an output based on a prompt consisting of a phrase of tokens. The target model acts as the primary system for ensuring the final output is contextually accurate and responsive to the user's initial input.

In some implementations, the target model comprises a large language model, such as an LLM including one or more transformer models. The target model may specifically be a non-autoregressive transformer that facilitates the verification of multiple tokens in parallel. By utilizing these architectures, the system can reduce the frequency of memory operations on model parameters and improve overall inference efficiency.

The method 600 can include, at 604, assigning one or more draft models to the request. A centralized manager accounts for the throughput and output of a plurality of draft models to load-balance incoming generative tasks among them. This assignment process ensures that the draft models generate "guess tokens" at a faster rate, which are then provided to the target model for parallel verification.

The one or more draft models are typically smaller models than the target model and may comprise non-autoregressive transformers. These draft models can have differing complexities, such as varying numbers of layers or parameter values, to handle different types of token generation challenges. In other configurations, each of the draft models may utilize a common configuration to simplify the distribution of requests across the system.

Furthermore, the method may include evicting key-value cache blocks associated with a second request from the key-value cache based on present load data associated with the one or more draft models. This eviction process is triggered when memory is allocated among a plurality of users in such a manner that enough memory to finish remaining computations is unavailable. The present load data used for these decisions can include the number of concurrent users assigned to the draft models or the specific availability of protected memory capacity.

The method 600 can include, at 606, assigning one or more cache lines of a key-value (KV) cache to the one or more draft models. Each user is initially assigned a single cache line to concentrate memory allocation within a particular area and reduce fragmentation. This assignment also establishes a maximum bound on the context length for a request, preventing the associated computing resources from growing indefinitely. In some implementations, the “assigning” of cache lines may use the memory functional units 307 of the processor 301. The “cache stepper” logic may be executed by the ICU 314 or specific vector function units 310 to manage pointers within the memory banks.

These cache lines can include a plurality of key-value cache blocks, which in turn correspond to a plurality of memory addresses. The cache manager determines the specific number of blocks to allocate for storing intermediate self-attention results based on system-wide factors and the specific needs of the draft model. In some implementations, these blocks map directly to logical or physical addresses within the memory units of a language processing unit.

The method 600 can include, at 608, for each of a plurality of decoding steps: obtaining a plurality of tokens from the one or more draft models; storing a key-value pair associated with the plurality of tokens in the key-value cache; and progressing the key-value cache using a cache stepper. The tokens obtained during this process generally comprise text data used to build the context of the response. The key-value pairs stored are associated with the self-attention mechanism, allowing the model to retrieve and reuse these results in subsequent steps without recalculating them.

The cache stepper is responsible for managing the local usage of these blocks and may deploy specific logic, such as sliding window attention. In a sliding window configuration, the stepper will begin to overwrite earlier context once the end of the context length is reached to allow for computations that exceed the initially allocated memory. This mechanism ensures continuous operation even when the cache manager is unable to provide additional memory space.

Finally, the method 600 can include rejecting, by the target model, a rejected token and rewinding the key-value cache to an earlier token prior to the rejected token. If the target model detects a mismatch, it communicates the position of the incorrect token to the draft models via a communications protocol. The system then resets to the context of the last accepted "golden" token, discarding any incorrect tokens and restarting the concurrent generation process.

In an aspect, the present disclosure provides a method. The method includes obtaining a request for a target model. The method includes assigning one or more draft models to the request. The method includes assigning one or more cache lines of a key-value (KV) cache to the one or more draft models. The method includes, for each of a plurality of decoding steps: obtaining a plurality of tokens from the one or more draft models; storing a key-value pair associated with the plurality of tokens in the KV cache; and progressing the KV cache using a cache stepper.

In some implementations, the method further includes rejecting, by the target model, a rejected token of the plurality of tokens and rewinding the KV cache to an earlier token prior to the rejected token.

In some implementations, the target model comprises a large language model (LLM).

In some implementations, the target model comprises a non-autoregressive transformer.

In some implementations, the one or more cache lines comprise a plurality of KV cache blocks.

In some implementations, the plurality of KV cache blocks comprise a plurality of memory addresses.

In some implementations, the one or more draft models comprise a non-autoregressive transformer.

In some implementations, the one or more draft models comprise a smaller model than the target model.

In some implementations, the plurality of tokens comprise text data.

In some implementations, the key-value pair is associated with an attention mechanism of the one or more draft models.

In some implementations, the one or more draft models comprise a plurality of draft models having differing configurations.

In some implementations, each of the one or more draft models comprise a common configuration.

In some implementations, the method further includes evicting KV cache blocks associated with a second request from the KV cache based on present load data associated with the one or more draft models.

In some implementations, the present load data comprises an availability of memory within the one or more cache lines associated with the one or more draft models.

In some implementations, the present load data comprises a number of concurrent users assigned to the one or more draft models.

In an aspect, the present disclosure provides a computing system having one or more processors and one or more non-transitory, computer-readable media storing instructions that, when implemented, cause the one or more processors to perform operations. The operations include obtaining a request for a target model. The operations include assigning one or more draft models to the request. The operations include assigning one or more cache lines of a key-value (KV) cache to the one or more draft models. The operations include, for each of a plurality of decoding steps: obtaining a plurality of tokens from the one or more draft models; storing a key-value pair associated with the plurality of tokens in the KV cache; and progressing the KV cache using a cache stepper.

In some implementations, the target model comprises a large language model (LLM).

In some implementations, the target model comprises a non-autoregressive transformer.

In some implementations, the one or more cache lines comprise a plurality of KV cache blocks.

In some implementations, the operations further include allocating one or more KV cache blocks associated with the assigned one or more cache lines to the one or more draft models.

In an aspect, the present disclosure provides one or more non-transitory, computer-readable media storing instructions that, when implemented, cause one or more processors to perform operations. The operations include obtaining a request for a target model. The operations include assigning one or more draft models to the request. The operations include assigning one or more cache lines of a key-value (KV) cache to the one or more draft models. The operations include allocating one or more KV cache blocks associated with the assigned one or more cache lines to the one or more draft models. The operations include, for each of a plurality of decoding steps: obtaining a plurality of tokens from the one or more draft models; storing a key-value pair associated with the plurality of tokens in the KV cache; and progressing the KV cache using a cache stepper.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method, comprising:
obtaining a request for a target model;
assigning one or more draft models to the request;
assigning one or more cache lines of a key-value (KV) cache to the one or more draft models; and
for each of a plurality of decoding steps:
obtaining a plurality of tokens from the one or more draft models;
storing a key-value pair associated with the plurality of tokens in the KV cache; and
progressing the KV cache using a cache stepper.

2. The method of claim 1, further comprising:
rejecting, by the target model, a rejected token of the plurality of tokens; and
rewinding the KV cache to an earlier token prior to the rejected token.

3. The method of claim 1, wherein the target model comprises a large language model (LLM).

4. The method of claim 1, wherein the target model comprises a non-autoregressive transformer.

5. The method of claim 1, wherein the one or more cache lines comprise a plurality of KV cache blocks.

6. The method of claim 5, wherein the plurality of KV cache blocks comprise a plurality of memory addresses.

7. The method of claim 1, wherein the one or more draft models comprise a non-autoregressive transformer.

8. The method of claim 1, wherein the one or more draft models comprise a smaller model than the target model.

9. The method of claim 1, wherein the plurality of tokens comprise text data.

10. The method of claim 1, wherein the key-value pair is associated with an attention mechanism of the one or more draft models.

11. The method of claim 1, wherein each of the one or more draft models comprises a common configuration.

12. The method of claim 1, further comprising evicting KV cache blocks associated with a second request from the KV cache based on present load data associated with the one or more draft models.

13. The method of claim 12, wherein the present load data comprises an availability of memory within the one or more cache lines associated with the one or more draft models.

14. The method of claim 12, wherein the present load data comprises a number of concurrent users assigned to the one or more draft models.

15. A computing system, comprising:
one or more processors; and
one or more non-transitory, computer-readable media storing instructions that, when implemented, cause the one or more processors to perform operations, the operations comprising:
obtaining a request for a target model;
assigning one or more draft models to the request;
assigning one or more cache lines of a key-value (KV) cache to the one or more draft models; and
for each of a plurality of decoding steps:
obtaining a plurality of tokens from the one or more draft models;
storing a key-value pair associated with the plurality of tokens in the KV cache; and
progressing the KV cache using a cache stepper.

16. The computing system of claim 15, wherein the target model comprises a large language model (LLM).

17. The computing system of claim 15, wherein the target model comprises a non-autoregressive transformer.

18. The computing system of claim 15, wherein the one or more cache lines comprise a plurality of KV cache blocks.

19. The computing system of claim 18, further comprising allocating one or more KV cache blocks associated with the assigned one or more cache lines to the one or more draft models.

20. One or more non-transitory, computer-readable media storing instructions that, when implemented, cause one or more processors to perform operations, the operations comprising:
obtaining a request for a target model;
assigning one or more draft models to the request;
assigning one or more cache lines of a key-value (KV) cache to the one or more draft models;
allocating one or more KV cache blocks associated with the assigned one or more cache lines to the one or more draft models; and
for each of a plurality of decoding steps:
obtaining a plurality of tokens from the one or more draft models;
storing a key-value pair associated with the plurality of tokens in the KV cache; and
progressing the KV cache using a cache stepper.
